(19) United States
(12) Patent Application Publication
(10) Pub. No.: US 2022/0324075 A1
(43) Pub. Date: Oct. 13, 2022

(54) Machine Tool Device

(71) Applicant: Robert Bosch GmbH, Stuttgart (DE)

(72) Inventors: Juergen Wiker, Stuttgart (DE); Daniel Dennis, Nuertingen (DE); Florian Esenwein, Leinfelden-Echterdingen (DE); Simon Riggenmann, Stuttgart (DE)

(21) Appl. No.: 17/753,372

(22) PCT Filed: Aug. 13, 2020
(86) PCT No.: PCT/EP2020/072770

§ 371 Date: Mar. 1, 2022

(30) Foreign Application Priority Data
Sep. 2, 2019 (DE) 10 2019 213 221.9
Jun. 18, 2020 (DE) 10 2020 207 520.4

(51) Int. Cl. B23Q 11/00; B23Q 17/24; B23Q 11/08

(52) U.S. Cl. CPC B23Q 11/0092; B23Q 17/2438; B23Q 17/2447; B23Q 11/0891; B23D 59/001

(57) ABSTRACT

A machine tool device includes at least one motorized machining tool, at least one, particularly capacitive, sensor unit, configured to detect at least one foreign body in at least one detection area around the machining tool, and at least one closed-loop and/or open-loop control unit configured to trigger at least one action depending on at least one signal from the sensor unit. The sensor unit includes at least one antenna configured to emit at least one electrical and/or magnetic field, which defines the at least one detection area, and/or to detect the at least one foreign body depending on at least one change in the at least one electrical and/or magnetic field.

### PRIOR ART

A machine tool device having at least one machining tool which can be driven by motor, having at least one, in particular capacitive, sensor unit which is configured to detect at least one foreign body in at least one detection area around the machining tool, and having at least one open-loop and/or closed-loop control unit which is configured to trigger at least one action on the basis of at least one signal from the sensor unit, has already been proposed.

### DISCLOSURE OF THE INVENTION

The invention is based on a machine tool device having at least one machining tool which can be driven by motor, having at least one, in particular capacitive, sensor unit which is configured to detect at least one foreign body in at least one detection area around the machining tool, and having at least one open-loop and/or closed-loop control unit which is configured to trigger at least one action on the basis of at least one signal from the sensor unit.

It is proposed that the sensor unit comprises at least one antenna which is configured to emit at least one electric and/or magnetic field, which defines the at least one detection area, and/or to detect the at least one foreign body on the basis of at least one change in at least one electric and/or magnetic field.

A machine tool preferably comprises the machine tool device. The machine tool device is preferably in the form of an electrically operated machine tool device. In particular, the machine tool is in the form of an electric machine tool. In particular, the machining tool can be driven by at least one electric motor of the machine tool device. The machine tool device preferably comprises at least one electrical energy storage unit, in particular a rechargeable battery, for supplying energy to at least the electric motor. Alternatively, it is conceivable for the machine tool device to be in the form of a pneumatically operated machine tool device, a gasoline-operated machine tool device or the like. The machine tool device is preferably provided for the purpose of cutting, sawing, planing, grinding or machining a workpiece in some other way that appears to make sense to a person skilled in the art. In particular, the machine tool may be in the form of a circular saw, in particular a handheld circular saw, a circular table saw, a chop and/or miter saw or the like, an angle grinder, a planing machine or the like. In particular, the machining tool is in the form of a saw blade, in particular a circular saw blade, a grinding disk, a planing roller or another machining tool which appears to make sense to a person skilled in the art. The term “provided” is intended to be understood as meaning, in particular, specially equipped and/or specially configured. The term “configured” is intended to be understood as meaning, in particular, specially programmed and/or specially designed. The fact that an object is provided or configured for a particular function is intended to be understood as meaning, in particular, the fact that the object performs and/or carries out this particular function in at least one application and/or operating state.

The sensor unit is preferably in the form of an electrical and/or magnetic, in particular capacitive, sensor unit. In particular, the sensor unit differs from an optical, acoustic, haptic sensor unit or the like. In particular, the sensor unit is configured for proximity detection. The sensor unit is preferably configured to detect the foreign body before contact with the machining tool. In particular, the sensor unit is configured to detect the foreign body at at least a certain distance from the machining tool, in particular within the detection area around the machining tool. The detection area is, in particular, an area which extends around the machining tool and in which the sensor unit is able and set up to detect the foreign body. The detection area preferably extends asymmetrically around the machining tool. The detection area preferably has a greater extent around points of the machining tool that are dangerous to an operator of the machine tool device, in particular along a cutting edge of the machine tool, than at other points of the machining tool. Alternatively, it is conceivable for the detection area to extend symmetrically, in particular spherically, around the machining tool.

A “foreign body” is intended to be understood as meaning, in particular, an object which is located in the detection area or moves into the detection area and prevents a machining operation, in particular. The foreign body may be, in particular, in the form of an animate object, in particular at least one body part of the operator, for example a hand, a finger, a leg or the like, an animal or another animate object that appears to make sense to a person skilled in the art. The foreign body may be, in particular, in the form of an inanimate object, in particular a disruptive object which is arranged on the workpiece and/or runs in a vicinity of the workpiece, for example a nail, a power line, a water pipe or the like.

An “open-loop and/or closed-loop control unit” is intended to be understood as meaning, in particular, a unit having at least one set of open-loop control electronics. A set of “open-loop control electronics” is intended to be understood as meaning, in particular, a unit having a processor unit and a storage unit as well as an operating program stored in the storage unit. The open-loop and/or closed-loop control unit is preferably connected to the sensor unit for signal transmission purposes, in particular via at least one signal line. Alternatively or additionally, it is conceivable for the open-loop and/or closed-loop control unit to be connected to the sensor unit for signal transmission purposes via a wireless signal connection. The open-loop and/or closed-loop control unit is preferably configured to actuate the sensor unit. The sensor unit is configured, in particular, to provide the open-loop and/or closed-loop control unit with the at least one signal, preferably a plurality of signals, in particular on the basis of detection of the at least one foreign body in the detection area. The open-loop and/or closed-loop control unit is preferably configured to evaluate the at least one signal received from the sensor unit. In particular, the open-loop and/or closed-loop control unit is configured to trigger the at least one action on the basis of evaluation of the at least one signal from the sensor unit.

The at least one action is preferably in the form of a safety function, in particular for preventing or at least minimizing injury to the operator, and/or a comfort function, in particular for making it easier for the operator to operate the machine tool device. The at least one action may be, in particular, in the form of braking of the machining tool, moving of the machining tool out of a hazardous area, shielding of the machining tool, outputting of at least one, in particular optical, acoustic and/or haptic, warning message, making of an emergency call or another action that appears to makes sense to a person skilled in the art. In particular, the open-loop and/or closed-loop control unit may be configured to trigger a plurality of, in particular different, actions. The open-loop and/or closed-loop control unit may preferably be configured to trigger different actions on the basis of different signals from the sensor unit. In particular, the open-loop and/or closed-loop control unit is configured to actuate at least one reaction unit of the machine tool device, which is provided for the purpose of carrying out the at least one action, on the basis of the at least one signal from the sensor unit, in particular for the purpose of triggering the at least one action. The at least one reaction unit may be, in particular, in the form of a braking unit, a covering unit, a pivoting unit, a blocking unit, an output unit, a communication unit or another unit that appears to makes sense to a person skilled in the art.

The at least one antenna is preferably configured to conduct electrical current. In particular, the at least one antenna is cylindrical, in particular circular-cylindrical. In particular, the at least one antenna is configured to emit an electric field distributed in a radially symmetrical manner about a longitudinal axis of the antenna and/or a magnetic field distributed concentrically about the longitudinal axis of the antenna.

A “longitudinal axis” of an object, in particular a circular-cylindrical object, is intended to be understood as meaning, in particular, an axis which is oriented perpendicularly to a cross-sectional area of the object that is spanned by transverse extents, in particular cylinder radii, of the object. The expression “perpendicular” is intended to define, in particular, an orientation of a direction relative to a reference direction, wherein the direction and the reference direction, in particular as seen in a projection plane, enclose an angle of 90° and the angle has a maximum deviation of in particular less than 8°, advantageously less than 5° and particularly advantageously less than 2°. The at least one antenna is preferably in the form of a cable, in particular a coaxial cable, a wire or the like. It is also conceivable for the antenna to be formed from a plurality of electrodes. This makes it possible to advantageously control a zone of influence of the electric and/or magnetic field that is produced. Alternatively or additionally, it is conceivable for the machining tool and/or an output shaft, on which the machining tool is mounted, to form the at least one antenna, and/or for the at least one antenna to be configured to be electrically coupled to the machining tool and/or to the output shaft. The machining tool is preferably in the form of the at least one antenna, wherein the sensor unit has at least one further antenna which is formed separately from the machining tool. Alternatively or additionally, it is conceivable for the at least one antenna to be formed separately from the machine tool device, in particular to be arranged on the operator, for example on a glove or protective goggles belonging to the operator.

In particular, the at least one antenna is configured to emit at least one electromagnetic field. In particular, the electric and/or magnetic, in particular electromagnetic, field of the at least one antenna, in particular a field strength and/or a maximum extent of the electric and/or magnetic field of the at least one antenna, depends on an electrical voltage applied to the at least one antenna and/or an electrical current flowing through the at least one antenna. In particular, the detection area at least substantially has an identical shape to the electric and/or magnetic, in particular electromagnetic, field of the at least one antenna. In particular, a boundary of the detection area is defined by a sum of all distances around the at least one antenna which have an identical minimum, in particular predefined, field strength of the electric and/or magnetic field of the at least one antenna. The at least one antenna is preferably arranged in a vicinity of the machining tool. In particular, the sensor unit may have a plurality of antennas, in particular for completely covering the machining tool with a detection area. In particular, the sensor unit may have at least two antennas, preferably at least four antennas, particularly preferably at least six antennas and very particularly preferably at least 8 antennas.

The at least one antenna is preferably configured to detect the foreign body on the basis of a change in the electric and/or magnetic field emitted by the at least one antenna. Alternatively or additionally, it is conceivable for the at least one antenna to be configured to detect the foreign body on the basis of a change in a further electric and/or magnetic field, in particular a field emitted by another antenna. In particular, the sensor unit may comprise at least two antennas, wherein a first antenna is configured to emit an electric and/or magnetic field, and wherein a second antenna is configured to detect the foreign body on the basis of a change in the electric and/or magnetic field of the first antenna. In particular, the foreign body arranged in the detection area changes the electric and/or magnetic field, in particular characteristic variables of the electric field, on the basis of electrical and/or magnetic properties of the foreign body. The at least one antenna is preferably configured to detect the foreign body capacitively, in particular on the basis of a change in the capacitance of the electric and/or magnetic field that is caused by the foreign body. Alternatively or additionally, it is conceivable for the at least one antenna to be configured to detect the foreign body inductively, in particular on the basis of a change in the inductance of the electric and/or magnetic field that is caused by the foreign body. The at least one antenna is preferably configured to detect a distance between the foreign body and the machining tool, in particular a position of the foreign body at least relative to the machining tool, a movement speed of the foreign body, in particular a speed with which the foreign body approaches the machining tool, and/or an acceleration of the foreign body, in particular an acceleration with which the foreign body approaches the machining tool.

In at least one exemplary embodiment in particular, the sensor unit may preferably comprise a tuning circuit which is connected to the antenna. The tuning circuit is at least provided, in particular, for the purpose of generating an electric and/or magnetic field by interacting with the antenna. The tuning circuit is preferably formed at least from a resonant circuit, in particular an RLC resonant circuit, and a phase stabilization circuit. An operating frequency of the tuning circuit is preferably less than 5 MHz. However, it is alternatively also conceivable for the operating frequency of the tuning circuit to be greater than 5 MHz. The tuning circuit has, in particular, at least one amplifier which is formed, for example, by a field effect transistor, a bipolar transistor, an operational amplifier or the like. Various amplifier topologies are also conceivable, for example a telescopic topology, a two-stage amplifier topology, a cascode topology or the like. The tuning circuit is preferably connected to a signal conditioning unit, in particular an analog/digital converter, wherein the signal conditioning unit can be connected at least to the open-loop and/or closed-loop control unit for the purpose of transmitting signals. The signal conditioning unit preferably comprises at least one comparator, in particular a Schmitt trigger, which can be used to convert an analog signal, preferably from the antenna, into a digital signal.

The configuration according to the invention of the machine tool device advantageously makes it possible to reliably detect at least one foreign object in a detection area. The foreign object can be advantageously detected in a preventative manner, in particular before contact with a machining tool. As a result of the detection, sufficient time for carrying out at least one action can be advantageously provided. A risk of injury for an operator can be advantageously kept low. It is advantageously possible to dispense with high-speed reaction systems that are cost-intensive, complex and/or damage the machining tool. A machine tool device which is safe and comfortable for an operator and exhibits low wear can be advantageously provided.

Furthermore, it is proposed that the open-loop and/or closed-loop control unit is configured to at least partially independently adapt at least one parameter on the basis of at least one operating parameter. The at least one operating parameter may be, in particular, in the form of a movement parameter, for example a movement speed of the machine tool device, an orientation parameter, for example a spatial orientation of the machine tool device, a machining parameter, for example a penetration depth of the machining tool, an operator-specific parameter, for example a skin conductivity of the operator, or another parameter that appears to makes sense to a person skilled in the art. The at least one parameter to be adapted may be, in particular, in the form of a sensitivity of the sensor unit, the detection area, in particular the extent of the detection area, the shape of the detection area or the like, a type of the at least one action to be triggered, a sequence of a plurality of actions to be triggered, a triggering speed and/or a performance speed of the at least one action, for example a braking speed of the machining tool, or another parameter that appears to make sense to a person skilled in the art.

The open-loop and/or closed-loop control unit is preferably configured to evaluate the at least one operating parameter. The open-loop and/or closed-loop control unit is preferably configured to at least partially independently adapt the at least one parameter on the basis of evaluation of the at least one operating parameter. The open-loop and/or closed-loop control unit is preferably configured to adapt the at least one parameter in a completely independent manner, in particular automatically, for example on the basis of a comparison of the at least one operating parameter with open-loop control routines stored in the storage unit of the open-loop and/or closed-loop control unit. Alternatively, it is conceivable for the open-loop and/or closed-loop control unit to be configured to partially independently adapt the at least one parameter. In particular, the open-loop and/or closed-loop control unit may be configured to provide the operator with at least one recommendation for adapting the at least one parameter on the basis of the at least one operating parameter, in particular on the basis of the evaluation of the at least one operating parameter, for example via an output unit of the machine tool device, and to adapt the at least one parameter on the basis of an operator input. The open-loop and/or closed-loop control unit may preferably be configured to at least partially independently adapt the at least one parameter, in particular a plurality of parameters, on the basis of a plurality of operating parameters. The open-loop and/or closed-loop control unit may preferably be configured to at least partially independently adapt a plurality of parameters on the basis of the at least one operating parameter. In order to increase operator safety, it is advantageously possible to tune the machine tool device in an at least partially automated manner that is comfortable for the operator.

It is also proposed that the open-loop and/or closed-loop control unit is configured to at least partially independently calibrate the sensor unit, in particular to adapt the at least one detection area, on the basis of the at least one operating parameter. In particular, the open-loop and/or closed-loop control unit is configured to at least partially independently calibrate the sensor unit as part of an operation of connecting the machine tool device and/or on the basis of an operator input. The open-loop and/or closed-loop control unit is preferably configured to calibrate the sensor unit, in particular to adapt the detection area, in a completely independent manner, in particular automatically, on the basis of the at least one operating parameter, in particular on the basis of the evaluation of the at least one operating parameter. Alternatively, it is conceivable for the open-loop and/or closed-loop control unit to be configured to partially independently calibrate the sensor unit. In particular, the open-loop and/or closed-loop control unit may be configured to provide the operator with at least one recommendation for calibrating the sensor unit on the basis of the at least one operating parameter, in particular on the basis of the evaluation of the at least one operating parameter, for example via the output unit of the machine tool device, and to calibrate the sensor unit on the basis of an operator input.

In particular, the open-loop and/or closed-loop control unit is configured, for the purpose of calibrating the sensor unit, to at least partially independently adapt the detection area of the sensor unit, in particular the extent and/or the shape of the detection area, on the basis of the at least one operating parameter, in particular on the basis of the evaluation of the at least one operating parameter. Alternatively or additionally, it is conceivable for the open-loop and/or closed-loop control unit to be configured, for the purpose of calibrating the sensor unit, to at least partially independently adapt the sensitivity of the sensor unit, a reaction behavior of the sensor unit to certain foreign bodies, in particular to certain materials, or another parameter of the sensor unit that appears to make sense to a person skilled in the art on the basis of the at least one operating parameter, in particular on the basis of the evaluation of the at least one operating parameter. For example, it is conceivable for the sensor unit to be configured, in particular during an operation of connecting the machine tool device, to detect an environment of the machine tool device, wherein the open-loop and/or closed-loop control unit is configured to calibrate the sensor unit on the basis of the detected environment. For example, it is conceivable for the sensor unit to detect a body part of an operator in a vicinity of the machining tool, which is arranged there for the purpose of guiding the machine tool, wherein the open-loop and/or closed-loop control unit reduces the detection area and/or reduces a sensitivity of the sensor unit, in particular for the purpose of reducing false triggering operations caused by the body part in the vicinity of the machining tool. The sensor unit can be advantageously calibrated in an at least partially automated manner in order to increase operator safety and operator comfort.

It is also proposed that the at least one operating parameter is in the form of a movement parameter and/or an orientation parameter. The at least one operating parameter in the form of a movement parameter may be, in particular, in the form of a movement speed of the machine tool device, a movement acceleration of the machine tool device, a direction of movement of the machine tool device or another movement parameter that appears to make sense to a person skilled in the art. The at least one operating parameter in the form of an orientation parameter may be, in particular, in the form of a spatial orientation, in particular alignment, of the machine tool device, in particular relative to a workpiece, relative to a vertical axis of the machine tool device, relative to a longitudinal axis of the machine tool device and/or relative to a transverse axis of the machine tool device. For example, it is conceivable for the open-loop and/or closed-loop control unit to be configured to trigger faster braking operations as actions, the higher the detected movement speed of the machine tool device. For example, it is conceivable for the open-loop and/or closed-loop control unit to be configured to trigger the fastest possible braking as an action on the basis of a detected free fall of the machine tool device. In order to increase operator safety and operator comfort, the machine tool device can be advantageously tuned in an at least partially automated manner on the basis of at least one movement parameter and/or on the basis of at least one orientation parameter.

It is also proposed that the at least one operating parameter is in the form of a machining parameter. The at least one operating parameter in the form of a machining parameter may be, in particular, in the form of a penetration depth of the machining tool in the workpiece, an inertia characteristic variable of the machining tool, a workpiece condition, in particular a workpiece hardness, a workpiece thickness, a workpiece material, a workpiece moisture, kickback of the machine tool device, a power consumption and/or a rotational speed of the motor driving the machining tool, a rotational speed of the machining tool or the like or another machining parameter that appears to make sense to a person skilled in the art. For example, it is conceivable for the open-loop and/or closed-loop control unit to set the detection area to be larger, the deeper the detected penetration depth of the machining tool. In order to increase operator safety and operator comfort, the machine tool device can be advantageously tuned in an at least partially automated manner on the basis of at least one machining parameter.

It is also proposed that the at least one operating parameter is in the form of an operator-specific parameter. The at least one operating parameter in the form of an operator-specific parameter may be, in particular, in the form of a skin conductivity of the operator, a method of operation typical of an operator, in particular an operating movement typical of an operator, operation of the machine tool device that is typical of an operator, a degree of experience of the operator or another operator-specific parameter that appears to make sense to a person skilled in the art. For example, it is conceivable for the open-loop and/or closed-loop control unit to be configured to set the sensitivity of the sensor unit to be lower, the greater the degree of experience of the operator. In order to increase operator safety and operator comfort, the machine tool device can be advantageously tuned in an at least partially automated manner on the basis of at least one operator-specific parameter.

It is also proposed that the machine tool device comprises at least one further sensor unit which is configured to record the at least one operating parameter. The further sensor unit preferably comprises at least one sensor element for recording the at least one operating parameter. In particular, the sensor unit may comprise a plurality of, in particular different, sensor elements, in particular a number of different sensor elements corresponding to a number of different operating parameters to be recorded. The further sensor unit is preferably configured to provide the open-loop and/or closed-loop control unit with the at least one recorded operating parameter, in particular in the form of at least one electrical signal. Alternatively or additionally, it is conceivable for the sensor unit, in particular the at least one antenna of the sensor unit, to be configured to record at least certain operating parameters. In particular, the further sensor unit may have at least one sensor element in the form of an acceleration sensor for the purpose of recording the at least one operating parameter in the form of a movement parameter. In particular, the further sensor unit may have at least one sensor element in the form of a position sensor, in particular a gyroscope, for the purpose of recording the at least one operating parameter in the form of an orientation parameter. In particular, the further sensor unit may have at least one sensor element in the form of an optical sensor, a moisture sensor, an acceleration sensor, an inertial sensor, a temperature sensor, a current and/or voltage sensor, a rate-of-rotation sensor or the like for the purpose of recording the at least one operating parameter in the form of a machining parameter. In particular, the further sensor unit may have at least one sensor element in the form of a conductivity sensor, a fingerprint scanner, a facial scanner or the like for the purpose of recording the at least one operating parameter in the form of an operator-specific parameter.

The further sensor unit, in particular the at least one sensor element of the further sensor unit, is preferably arranged on and/or in a housing unit of the machine tool device. Alternatively or additionally, it is conceivable for the further sensor unit to be arranged separately from the housing unit of the machine tool device and to have, in particular, at least one, in particular wireless communication unit, for transmitting the at least one recorded operating parameter to the open-loop and/or closed-loop control unit. The further sensor unit is preferably configured to record the at least one operating parameter during operation of the machine tool device, in particular continuously, and/or during an operation of connecting the machine tool device. For example, it is conceivable for the further sensor unit to be configured to record an operating parameter in the form of a mass inertia of the machining tool when ramping up the rotational speed of the machining tool to an operating rotational speed. The at least one operating parameter can be advantageously recorded in a manner comfortable for a user, in particular automatically.

It is also proposed that the further sensor unit has at least one sensor element which is configured to record at least one conductivity characteristic variable of at least one operator. The sensor element is preferably in the form of a conductivity sensor. The conductivity characteristic variable describes, in particular, an ability to conduct electrical current. In particular, the conductivity characteristic variable is in the form of a skin conductivity of the operator, in particular of at least one hand of the operator. The conductivity characteristic variable is preferably in the form of an operator-specific parameter. The sensor element is preferably arranged on at least one handle of the machine tool device. The open-loop and/or closed-loop control unit is preferably configured to at least partially independently adapt the at least one parameter, in particular to calibrate the sensor unit, on the basis of the recorded conductivity characteristic variable, in particular on the basis of evaluation of the recorded conductivity characteristic variable. In particular, different conductivity characteristic variables, for example of different operators, hands with different levels of moisture, hands with different levels of heat, hands with different levels of blood circulation or the like, give rise to different changes, in particular capacitance changes, in the electric and/or magnetic field of the at least one antenna. The open-loop and/or closed-loop control unit is preferably configured to calibrate the sensor unit differently, in particular to set a sensitivity of the sensor unit differently, on the basis of different conductivity characteristic variables. In particular, the open-loop and/or closed-loop control unit is configured to set the sensitivity of the sensor unit to be higher, the lower the conductivity characteristic variable, in particular the skin conductivity, of the operator. In order to increase operator safety and operator comfort, the machine tool device, in particular the sensor unit, can be advantageously matched to electrical and/or magnetic, in particular capacitive, properties of an operator in an at least partially automated manner.

It is also proposed that the machine tool device comprises at least one, in particular wireless, communication unit which is configured to receive the at least one operating parameter from at least one external unit. The communication unit of the machine tool device is preferably in the form of a wireless communication unit, in particular a WLAN module, a radio module, a Bluetooth module, an NFC module or the like. Alternatively or additionally, it is conceivable for the communication unit of the machine tool device to be in the form of a wired communication unit, in particular a USB connection, an Ethernet connection, a coaxial connection or the like. The communication unit of the machine tool device is preferably connected to the open-loop and/or closed-loop control unit for signal transmission purposes, in particular via at least one signal line. In particular, the communication unit of the machine tool device is configured to provide the open-loop and/or closed-loop control unit with the at least one operating parameter, in particular in the form of at least one electrical signal.

The external unit may be, in particular, in the form of a smartphone, a server, in particular a cloud server and/or a database server, augmented reality glasses, a computer, an external sensor unit or another external unit that appears to make sense to a person skilled in the art. In particular, the external unit is formed separately from the machine tool device. The external unit is preferably configured to record, store and/or obtain the at least one operating parameter, for example from a further sensor unit, from a database, from the Internet or from another source that appears to make sense to a person skilled in the art. In particular, the external unit comprises at least one communication unit which is configured to transmit the at least one operating parameter to the machine tool device, in particular to the communication unit of the machine tool device. The communication unit of the external unit may be designed, in particular, in an at least substantially similar manner to the communication unit of the machine tool device. The communication unit of the machine tool device may preferably be configured to provide the external unit with identification data relating to the machine tool device, wherein the external unit can provide the machine tool device with at least one operating parameter matching the identification data, in particular. A further possible way of determining the at least one operating parameter in a comfortable manner for an operator can be advantageously provided.

It is also proposed that the open-loop and/or closed-loop control unit is configured to trigger the at least one action on the basis of joint evaluation of the at least one signal from the sensor unit and the at least one operating parameter. In particular, the open-loop and/or closed-loop control unit is configured to evaluate, in particular weight, the at least one signal from the sensor unit taking into account the at least one operating parameter and/or to evaluate, in particular weight, the at least one operating parameter taking into account the at least one signal from the sensor unit. In particular, the open-loop and/or closed-loop control unit may be configured to prevent the at least one action on the basis of the joint evaluation of the at least one signal from the sensor unit and the at least one operating parameter. In particular, the open-loop and/or closed-loop control unit may be configured to trigger the at least one action, in particular a plurality of actions, on the basis of joint evaluation of the at least one signal from the sensor unit, in particular a plurality of signals from the sensor unit, and the at least one operating parameter, in particular a plurality of operating parameters. A high degree of operator safety can be advantageously achieved and false triggering operations can be kept low.

It is also proposed that the open-loop and/or closed-loop control unit is configured to trigger different actions on the basis of different results of joint evaluations of the at least one signal from the sensor unit and the at least one operating parameter. The open-loop and/or closed-loop control unit is preferably configured to trigger the at least one action, which enables an optimum combination of operator safety and operator comfort, on the basis of the result of the joint evaluation of the at least one signal from the sensor unit and the at least one operating parameter. For example, it is conceivable for the open-loop and/or closed-loop control unit to be configured to trigger motor braking of the motor driving the machining tool on the basis of a low speed with which the foreign body approaches the machining tool and a low mass inertia of the machining tool, in particular in order to brake the machining tool to a standstill before being touched by the foreign body with a simultaneously low mechanical load on the machining tool. For example, it is conceivable for the open-loop and/or closed-loop control unit to be configured to trigger mechanical braking of the machining tool, on the basis of a higher speed with which the foreign body approaches the machining tool and/or a higher mass inertia of the machining tool, in addition to the motor braking of the motor driving the machining tool, which, in the present situation, would not be able, in particular, to brake the machining tool to a standstill before contact of the foreign body with the machining tool. In particular, actions to be triggered in each case are assigned to a plurality of possible results, preferably each possible result, of joint evaluations of the at least one signal from the sensor unit and the at least one operating parameter in the storage unit of the open-loop and/or closed-loop control unit. The open-loop and/or closed-loop control unit is preferably configured to trigger the at least one action assigned to the respective result of the evaluation. A reliable machine tool device with a high degree of operator comfort and a high degree of operator safety can be advantageously provided.

It is also proposed that the sensor unit is configured to provide a plurality of detection areas of different radii around the machining tool. The at least one antenna is preferably configured to provide the plurality of detection areas of different radii around the machining tool. Alternatively or additionally, it is conceivable for the sensor unit to comprise a plurality of antennas, in particular a number of antennas corresponding to a number of detection areas to be provided, wherein an antenna is respectively configured, in particular, to provide at least one of the plurality of detection areas. A “radius of a detection area around the machining tool” is intended to be understood as meaning, in particular, a maximum extent of the detection area from the machining tool, in which the sensor unit is still configured to detect the foreign body. The detection areas are preferably in the form of layers or shells, in particular cylindrical shells, spherical shells or the like. In particular, the detection areas have equidistant extents between one another, as seen along the radii of the detection areas. Alternatively, it is conceivable for the detection areas to have differing extents between one another, as seen along the radii of the detection areas.

The open-loop and/or closed-loop control unit is preferably configured to determine a distance between the foreign body and the machining tool on the basis of detection of the foreign body in a particular detection area. In particular, the open-loop and/or closed-loop control unit is configured to determine the movement speed of the foreign body, in particular the speed with which the foreign body approaches the machining tool, on the basis of a period of time that has elapsed between operations of detecting the foreign body in two different detection areas, in particular detection areas adjoining one another, and on the basis of extents of the detection areas. The open-loop and/or closed-loop control unit is preferably configured to determine the movement acceleration of the foreign body, in particular the acceleration with which the foreign body approaches the machining tool, on the basis of different determined movement speeds of the foreign body in different detection areas. The foreign body can be advantageously detected and tracked in a particularly precise manner.

It is also proposed that the open-loop and/or closed-loop control unit is configured to trigger different actions, in particular in a cascaded manner, on the basis of different signals from the sensor unit corresponding to operations of detecting the at least one foreign body in different detection areas. In particular, the open-loop and/or closed-loop control unit is configured to trigger different actions, in particular in a cascaded manner, on the basis of different distances between the foreign body and the machining tool. The fact that the open-loop and/or closed-loop control unit is configured “to trigger different actions in a cascaded manner” is intended to be understood as meaning, in particular, the fact that the open-loop and/or closed-loop control unit is configured to trigger a plurality of different actions in succession. In particular, it is conceivable for the open-loop and/or closed-loop control unit to be configured to trigger output of a warning signal on the basis of a signal from the sensor unit corresponding to detection of the foreign body in a first detection area at a maximum distance from the machining tool. In particular, it is conceivable for the open-loop and/or closed-loop control unit to be configured to trigger switching-off of the motor driving the machining tool on the basis of a signal from the sensor unit corresponding to detection of the foreign body in a second detection area at a shorter distance from the machining tool than the first detection area. In particular, it is conceivable for the open-loop and/or closed-loop control unit to be configured to trigger mechanical braking of the machining tool on the basis of a signal from the sensor unit corresponding to detection of the foreign body in a third detection area at a shorter distance from the machining tool than the second detection area. The open-loop and/or closed-loop control unit is preferably configured to trigger a plurality of different actions, in particular in a cascaded manner, on the basis of a plurality of successive different signals from the sensor unit corresponding to a movement of the foreign body through different detection areas. In particular, it is conceivable for the open-loop and/or closed-loop control unit to trigger the output of the warning signal, the switching-off of the motor driving the machining tool and the mechanical braking of the machining tool in a cascaded manner on the basis of a plurality of successive different signals from the sensor unit corresponding to a movement of the foreign body into the first detection area, from the first detection area into the second detection area and from the second detection area into the third detection area. False triggering operations and wear of the machining tool can be advantageously kept low. A low-wear machine tool device can be advantageously provided.

It is also proposed that the open-loop and/or closed-loop control unit is configured to classify different foreign bodies detected by the sensor unit and to trigger different actions on the basis of different classifications. In particular, the open-loop and/or closed-loop control unit is configured to distinguish between different types of foreign bodies on the basis of different signals from the sensor unit. In particular, different types of foreign bodies have different electrical and/or magnetic, in particular capacitive, properties, in particular influence the electric and/or magnetic field of the at least one antenna differently. In particular, each type of foreign body has its own electrical and/or magnetic, in particular capacitive, signature. The open-loop and/or closed-loop control unit is preferably configured to identify a type of the foreign body on the basis of the electrical and/or magnetic, in particular capacitive, signature of the foreign body and to classify the foreign body. Electrical and/or magnetic, in particular capacitive, signatures of different types of foreign bodies are preferably stored in the storage unit of the open-loop and/or closed-loop control unit. In particular, the open-loop and/or closed-loop control unit is configured to compare a signal from the sensor unit corresponding to detection of a foreign body with the stored signatures and to classify the foreign body on the basis of the comparison.

In particular, the open-loop and/or closed-loop control unit is configured to distinguish between animate and inanimate foreign bodies on the basis of different signals from the sensor unit and to classify the foreign bodies accordingly. The open-loop and/or closed-loop control unit is preferably configured to distinguish between human and animal animate foreign bodies on the basis of different signals from the sensor unit and to classify the foreign bodies accordingly. The open-loop and/or closed-loop control unit is preferably configured to distinguish between inanimate foreign bodies of different material on the basis of different signals from the sensor unit and to classify the foreign bodies accordingly. Different actions to be triggered are preferably stored in the storage unit of the open-loop and/or closed-loop control unit in a manner assigned to different classifications of foreign bodies. In particular, the open-loop and/or closed-loop control unit is configured to trigger at least one action assigned to a classification of a detected foreign body. For example, it is conceivable for the open-loop and/or closed-loop control unit to be configured to trigger pivoting of the machining tool out of a hazardous area on the basis of a detected foreign body which is classified as an inanimate foreign body, and to trigger mechanical braking of the machining tool on the basis of a detected foreign body which is classified as an animate foreign body. An action specific to a foreign body can be advantageously triggered.

It is also proposed that the machine tool device comprises at least one mechanical braking unit which is provided for the purpose of braking the machining tool, wherein the open-loop and/or closed-loop control unit is configured to use at least one electrical current of a motor braking operation to actuate the mechanical braking unit. The mechanical braking unit is preferably provided for the purpose of mechanically braking the, in particular moving, in particular rotating, machining tool, in particular until the machining tool comes to a standstill. The mechanical braking unit is preferably provided for the purpose of actively braking the machining tool, in particular by establishing a force fit and/or form fit with the machining tool and/or with an output shaft, on which the machining tool is mounted. In particular, the mechanical braking unit comprises at least one mechanical braking element, in particular a brake shoe, a wrap spring, a blocking pin or the like, which can be coupled in a force-fitting and/or form-fitting manner to the machining tool and/or to the output shaft in order to actively brake the machining tool. Alternatively or additionally, it is conceivable for the mechanical braking unit to be provided for the purpose of passively braking the machining tool, in particular by decoupling the machining tool from the motor driving the machining tool. The mechanical braking unit is preferably provided for the purpose of braking the machining tool, until the machining tool comes to a standstill, at the latest 200 milliseconds after the mechanical braking has been triggered. The mechanical braking unit is preferably provided for the purpose of braking the machining tool with such a braking force that the machining tool at least temporarily slides relative to the output shaft, in particular moves more quickly than the output shaft, during braking.

The open-loop and/or closed-loop control unit is preferably configured to carry out the motor braking, in particular to actuate the motor driving the machining tool to perform a braking operation. In particular, the open-loop and/or closed-loop control unit may be configured to carry out motor braking operations of different severity on the basis of different power consumptions of the motor. In particular, the open-loop and/or closed-loop control unit is configured to switch off, short-circuit, reverse the polarity of or similarly act on the motor driving the machining tool, in particular an electric motor, in order to achieve a motor braking operation. In particular, at least one electrical current, in particular a greater electrical current than during normal operation of the motor, flows during motor braking. The open-loop and/or closed-loop control unit is preferably configured to use the at least one electrical current of the motor braking to actuate at least one triggering unit, in particular to conduct the at least one electrical current of the motor braking to the triggering unit. In particular, the open-loop and/or closed-loop control unit or the mechanical braking unit comprises the triggering unit. The triggering unit is preferably provided for the purpose of releasing the at least one mechanical braking element and/or at least one braking actuator of the mechanical braking unit. The triggering unit may be, in particular, in the form of a shape memory metal, a relay, an electromagnet, a fuse wire or another triggering unit that appears to make sense to a person skilled in the art. In particular, the at least one electrical current of the motor braking may deform a triggering unit in the form of a shape memory metal, may switch a triggering unit in the form of a relay or an electromagnet and/or may fuse a triggering unit in the form of a fuse wire. The machining tool can be advantageously mechanically braked in an efficient manner that is safe for an operator.

It is also proposed that the machine tool device comprises at least one pivoting unit for mounting the machining tool in a pivotable manner, wherein the open-loop and/or closed-loop control unit is configured to at least partially independently adapt the at least one parameter, in particular the at least one detection area, on the basis of at least one pivot angle of the machining tool. The machine tool device preferably comprises the pivoting unit as an alternative or in addition to the mechanical braking unit. In particular, a machine tool in the form of a chop and/or miter saw comprises the machine tool device which comprises the pivoting unit for mounting the machining tool in a pivotable manner. The pivoting unit preferably comprises at least one pivot arm, on which the machining tool is mounted, and at least one pivot bearing, in particular a swivel joint, which is provided for the purpose of mounting the pivot arm relative to a base unit of the machine tool device in a pivotable manner, in particular about a pivot axis. In particular, the pivoting unit may comprise at least one further pivot bearing, in particular a tilt joint, which is provided for the purpose of mounting the pivot arm relative to the base unit in a pivotable manner about a further pivot axis, in particular a pivot axis running perpendicular to the pivot axis. The machine tool device preferably comprises at least one pivot sensor unit which is configured to detect the at least one pivot angle of the machining tool, in particular of the pivot arm, relative to the base unit, in particular relative to a base area of the base unit, and to make it available to the open-loop and/or closed-loop control unit.

The sensor unit, in particular the at least one antenna, is preferably arranged on the base unit. In particular, a distance between the at least one antenna and the machining tool is dependent on the at least one pivot angle of the machining tool. The open-loop and/or closed-loop control unit is preferably configured to actuate the sensor unit such that a minimum extent of the detection area around the machining tool is kept constant independently of the at least one pivot angle of the machining tool. In particular, the open-loop and/closed-loop control unit is configured to adapt the detection area on the basis of the at least one pivot angle of the machining tool. In particular, the open-loop and/or closed-loop control unit is configured to enlarge the detection area on the basis of the machining tool moving away, in particular pivoting away, from the at least one antenna. In particular, the open-loop and/or closed-loop control unit is configured to reduce the detection area on the basis of the machining tool approaching, in particular pivoting toward, the at least one antenna. A pivotably mounted machining tool can be advantageously covered with a detection area in a manner that is particularly safe for an operator.

It is also proposed that the machine tool device comprises at least one blocking unit for blocking the pivoting unit, wherein the open-loop and/or closed-loop control unit is configured to actuate the blocking unit to block the pivoting unit on the basis of at least the at least one signal from the sensor unit. The blocking unit is preferably provided for the purpose of preventing pivoting of the machining tool, in particular the pivot arm. In particular, the blocking unit is provided for the purpose of blocking the at least one pivot bearing. In particular, the blocking unit comprises at least one blocking element, for example a setscrew, a blocking pin, a drag shoe or the like, which is provided for the purpose of blocking the at least one pivot bearing. In particular, blocking of the pivoting unit, in particular of the at least one pivot bearing, is in the form of an action to be triggered by the open-loop and/or closed-loop control unit on the basis of the at least one signal from the sensor unit, in particular on the basis of detection of the foreign body. In particular, the open-loop and/or closed-loop control unit is configured to trigger the blocking of the pivoting unit by actuating the blocking unit. In particular, the open-loop and/or closed-loop control unit is configured to actuate the blocking unit, as an alternative or in addition to the motor, the output unit, an emergency call unit of the machine tool device and/or mechanical braking unit, on the basis of the at least one signal from the sensor unit. As an alternative or in addition to the blocking unit, it is conceivable for the machine tool device to have at least one emergency pivoting actuator, wherein the open-loop and/or closed-loop control unit is configured to actuate the emergency pivoting actuator to convey, in particular pivot, the machining tool out of the hazardous area on the basis of the at least one signal from the sensor unit. Pivoting of the machining tool onto the foreign body can be advantageously prevented and a risk of injury can be minimized.

It is also proposed that the machine tool device comprises at least one protective unit which surrounds the at least one antenna at least in sections and is provided for the purpose of protecting the at least one antenna from environmental influences. The at least one protective unit is preferably provided for the purpose of protecting the at least one antenna from mechanical environmental influences, in particular shocks, vibrations, abrasion or the like. In particular, the at least one protective unit may be at least partially formed from an at least partially shock-absorbing and/or abrasion-resistant material, for example a rubber, a silicone or the like. The protective unit is preferably formed from an electrically insulating material. In particular, impact protection of the machine tool device may form the at least one protective unit at least in sections. In particular, the at least one antenna may be integrated at least in sections into the impact protection of the machine tool device. The at least one protective unit is preferably provided for the purpose of protecting the at least one antenna from weather-related and/or environment-related environmental influences, in particular moisture, frost, heat or the like. In particular, the at least one protective unit may be at least partially formed from an at least partially fluid-tight, in particular watertight, and/or thermally insulating material. The at least one protective unit preferably completely surrounds the at least one antenna, in particular as seen along any desired spatial direction. Alternatively, it is conceivable for the at least one protective unit to surround the at least one antenna in sections, for example at least on a workpiece support surface. The at least one protective unit is preferably molded onto the at least one antenna and/or onto at least one shielding unit of the machine tool device at least in sections, in particular injection molded around the at least one antenna and/or the at least one shielding unit. Alternatively, it is conceivable for the at least one antenna and/or the at least one shielding unit to be inserted, clamped, adhesively bonded, welded, soldered or the like at least in sections into the at least one protective unit. The machine tool device may preferably have a plurality of protective units, in particular a number of protective units corresponding to a number of antennas. Alternatively or additionally, it is conceivable for an individual protective unit to be provided for the purpose of receiving a plurality of antennas, in particular surrounding them at least in sections. The at least one antenna can be advantageously protected from environmental influences. A sensor unit having a low-wear antenna can be advantageously provided.

It is also proposed that the machine tool device comprises at least one, in particular the at least one above-mentioned, shielding unit which surrounds the at least one antenna at least in sections and is provided for the purpose of shielding at least one electric and/or magnetic field of the at least one antenna, which defines the at least one detection area, along at least one emission direction. The at least one shielding unit is preferably formed from a material that is not transparent to electromagnetic radiation, in particular electric and/or magnetic fields, in particular from a metal, for example from a lead, an iron, a steel or the like. In particular, the at least one shielding unit is provided for the purpose of absorbing and/or reflecting the electric and/or magnetic field of the at least one antenna along the at least one emission direction. It is additionally conceivable for the at least one shielding unit to be configured to focus the electric and/or magnetic field of the at least one antenna along at least one emission direction without shielding. The at least one shielding unit preferably surrounds the at least one antenna in sections. In particular, the at least one antenna is arranged without shielding, as seen along at least one emission direction. In particular, at least one hazardous area of the machining tool, for example a cutting edge of the machining tool, is arranged along the at least one emission direction, along which the at least one antenna is arranged without shielding.

It is also proposed that the sensor unit, in particular in at least one exemplary embodiment, comprises at least one electrical or electronic shielding circuit which is configured to shield an electric and/or magnetic field emitted by the antenna along at least one emission direction. An emission direction of the antenna can be set, in particular, by means of the shielding circuit. The shielding circuit is preferably in the form of a high-impedance circuit. The shielding circuit preferably comprises at least one high-impedance electrical component. In particular, the antenna and/or the tuning circuit of the sensor unit is/are connected to an input of the shielding circuit. At least one output of the shielding circuit is preferably grounded. The shielding circuit preferably has a higher impedance at the input of the shielding circuit than at the output of the shielding circuit. For example, the impedance at the input of the shielding circuit is of the order of magnitude of 100 MΩ and the impedance at the output of the shielding circuit is of the order of magnitude of 10 MΩ or less. It is therefore advantageously possible for the field lines of the electric and/or magnetic field to be emitted from the antenna at least substantially along an emission direction. However, it is also conceivable, in principle, for the orders of magnitude at the input and output to differ from the above-mentioned values. The electric and/or magnetic field of the at least one antenna can be advantageously oriented. An electric and/or magnetic field can be advantageously directed to a desired area in which foreign bodies are intended to be detected. An orientation of the electric and/or magnetic field can be advantageously adapted in a particularly simple manner.

In particular, the at least one shielding unit may surround the at least one protective unit at least in sections and/or the at least one protective unit may surround the at least one shielding unit at least in sections. In particular, the at least one protective unit may be integrated at least in sections into the at least one shielding unit and/or the at least one shielding unit may be integrated at least in sections into the at least one protective unit. The at least one protective unit and the at least one shielding unit may preferably have a one-piece design. The term “one-piece” is intended to be understood as meaning, in particular, formed in one piece. This one piece is preferably produced from a single blank, a mass and/or a casting, particularly preferably in an injection molding method, in particular a single-component and/or multi-component injection molding method.

In particular, the machine tool device may have at least one combined protective and shielding unit. The at least one shielding unit is preferably molded at least in sections onto the at least one antenna and/or onto the at least one protective unit, in particular molded around the at least one antenna and/or around the at least one protective unit. Alternatively, it is conceivable for the at least one antenna and/or the at least one protective unit to be inserted, clamped, adhesively bonded, welded, soldered or the like at least in sections into the at least one shielding unit. The machine tool device may preferably have a plurality of shielding units, in particular a number of shielding units corresponding to a number of antennas. Alternatively or additionally, it is conceivable for a single shielding unit to be provided for the purpose of receiving a plurality of antennas, in particular surrounding them at least in sections. The electric and/or magnetic field of the at least one antenna can be advantageously oriented. The at least one shielding unit is preferably formed at least in sections by a table, a base plate, a sliding plate or the like of the machine tool device. False triggering operations can be advantageously reduced and operator comfort can be increased.

It is also proposed that the machine tool device comprises at least one workpiece support surface, wherein the sensor unit comprises at least one further antenna which has at least one emission direction running anti-parallel to at least one emission direction of the at least one antenna and transversely, in particular perpendicularly, to the workpiece support surface. In particular, the table of the machine tool device, the base plate of the machine tool device, the sliding plate of the machine tool device or another component of the machine tool device that appears to make sense to a person skilled in the art may comprise the workpiece support surface. In particular, the at least two antennas are arranged on sides of the component which face away from one another. The at least one antenna is preferably arranged on the workpiece support surface and the at least one further antenna is arranged on a further surface of the machine tool device that faces away from the workpiece support surface. In particular, the workpiece support surface and the further surface extend parallel to one another. In particular, the at least one antenna and the at least one further antenna extend parallel to one another. The term “parallel” is intended to be understood as meaning, in particular, an orientation of a direction relative to a reference direction, in particular in a plane, wherein the direction has a deviation of in particular less than 8°, advantageously less than 5° and particularly advantageously less than 2° with respect to the reference direction. The expression “anti-parallel” is intended to define, in particular, an orientation of a direction relative to a reference direction, wherein the direction and the reference direction, in particular as seen in a projection plane, enclose an angle of 180° and the angle has a maximum deviation of in particular less than 8°, advantageously less than 5° and particularly advantageously less than 2°.

The at least one antenna preferably has a plurality of emission directions which run transversely to a respective emission direction of the at least one further antenna. In particular, the at least one emission direction, preferably each emission direction, of the at least one antenna points away from the at least one further antenna. In particular, the at least one shielding unit shields the electric and/or magnetic field of the at least one antenna at least along a direction pointing toward the at least one further antenna. In particular, the at least one emission direction, preferably each emission direction, of the at least one further antenna points away from the at least one antenna. In particular, at least one further shielding unit of the machine tool device shields an electric and/or magnetic field of the at least one further antenna at least along a direction pointing toward the at least one antenna. The machining tool preferably extends in at least one operating state at least in sections through the workpiece support surface and/or through the further surface, in particular through the component having the workpiece support surface and the further surface. A detection area defined by the electric and/or magnetic field of the at least one antenna preferably covers a hazardous area, in particular a cutting edge, of the machining tool that is arranged on the side of the workpiece support surface and a detection area defined by the electric and/or magnetic field of the at least one further antenna covers a hazardous area, in particular the cutting edge, of the machining tool that is arranged on the side of the further surface. A machine tool device having a workpiece support surface and complete sensor-based coverage of the machining tool can be advantageously provided.

It is also proposed that the at least one antenna has a non-linear profile and surrounds the machining tool, as seen in at least one plane, along at least two sides. The at least one antenna preferably surrounds the machining tool, as seen at least in a plane parallel to the workpiece support surface, in particular in the workpiece support surface, along at least two sides. In particular, the at least one antenna surrounds the machining tool, as seen in the at least one plane, along at least two sides, preferably along at least three sides and particularly preferably along four sides. In particular, the machining tool has, as seen in the at least one plane, two hazardous sides, in particular cutting edge sides, and two blade sides. The at least one antenna preferably surrounds the machining tool, as seen in the at least one plane, along at least hazardous side and along at least one blade side. The at least one antenna preferably describes, at least in sections, at least one curve, at least one bend, at least one corner or at least one other non-linear shape that appears to make sense to a person skilled in the art. In particular, as seen in the at least one plane, the at least one antenna has an L-shaped profile, in particular two sections which are arranged transversely, in particular perpendicularly, to one another, a U-shaped profile, in particular two sections which are arranged parallel to one another and are connected to one another by means of a third section which is arranged transversely, in particular perpendicularly, to the two sections, or another non-linear profile that appears to make sense to a person skilled in the art. The sensor unit may preferably have a plurality of antennas, in particular two antennas, which surround the machining tool, as seen in the at least one plane, in particular along at least two different sides. The machining tool can be advantageously covered using sensors on different sides and a high degree of operator safety can be achieved.

It is also proposed that the machine tool device comprises at least one protective hood for the machining tool, wherein the sensor unit comprises at least one further antenna which is arranged at at least one further end point of the protective hood that faces away from an end point of the protective hood at which the at least one antenna is arranged. The protective hood is preferably provided for the purpose of covering the machining tool, in particular the cutting edge of the machining tool, at least in sections. The protective hood preferably has a partial-disk-shaped, in particular half-disk-shaped, cross section, as seen parallel to the output shaft on which the machining tool is mounted. In particular, the protective hood is pivotably mounted on and/or around the output shaft. In particular, the machining tool has different hazardous areas, in particular different exposed sections of the cutting edge, depending on different pivot angles of the protective hood. In particular, the hazardous area, in particular the exposed cutting edge, of the machine tool can extend from the end point of the protective hood along the cutting edge to the further end point of the protective hood. In particular, the hazardous area of the machining tool is in the form of an area of the machining tool without a protective hood. The at least two antennas, in particular the detection areas of the at least two antennas, are preferably shifted with pivoting of the protective hood, in particular in a manner proportional to a pivot angle of the protective hood. Optimum sensor-based coverage of the machining tool, in particular of the at least one hazardous area of the machining tool, can be advantageously achieved in any desired angular position of the protective hood. A machine tool device which is safe and comfortable for an operator and has a protective hood can be advantageously provided.

The invention is also based on a method for operating a machine tool device, in particular a machine tool device according to the invention.

It is proposed that, in at least one method step, at least one, in particular the at least one above-mentioned, antenna is used to emit at least one electric and/or magnetic field, which defines at least one detection area around at least one, in particular the above-mentioned, machining tool of the machine tool device, and/or that the at least one antenna is used to detect at least one foreign body on the basis of at least one change in at least one electric and/or magnetic field.

In at least one method step, at least one parameter is preferably at least partially independently adapted on the basis of at least one operating parameter, in particular by the open-loop and/or closed-loop control unit. It is advantageously possible to provide a method which can be used to enable low-maintenance operation of a machine tool device in a manner which is safe and comfortable for an operator.

The invention is also based on a machine tool having at least one machine tool device according to the invention. It is advantageously possible to provide a low-wear machine tool which can be used in a manner which is safe and comfortable for an operator.

The invention is also based on a system having at least one machine tool according to the invention and at least one display device which is configured to display at least one hazardous area around at least one, in particular the above-mentioned, machining tool of at least one, in particular the above-mentioned, machine tool device of the machine tool.

It is proposed that the display device is configured to adapt a display of the at least one hazardous area on the basis of a change in at least one parameter, in particular on the basis of a change in at least one detection area around the machining tool. The display device may be arranged on the machine tool, in particular, or may be formed separately from the machine tool. The display device is preferably in the form of an optical display device, in particular is configured to optically display the hazardous area. In particular, the display device has at least one illumination element, for example a light-emitting diode, a laser diode or the like, and/or a display element, for example a screen, for displaying the hazardous area. In particular, the display device may be in the form of a projector, a smartphone, augmented reality glasses or another display device that appears to make sense to a person skilled in the art. In particular, the display device is configured to project, illuminate or the like the hazardous area, in particular at least boundaries of the hazardous area, around the machining tool in a working area and/or to display the hazardous area, in particular at least the boundaries of the hazardous area, in an image, in particular a live image, of the machine tool, for example in a signal color. In particular, the display device may have at least one camera for recording the image, in particular the live image, of the machine tool.

A change in the hazardous area, in particular in the boundaries of the hazardous area, is preferably proportional to a change in the detection area, in particular boundaries of the detection area. In particular, the open-loop and/or closed-loop control unit is configured to enlarge the detection area on the basis of an enlargement of the hazardous area, for example on account of an increase in the rotational speed of the machining tool, and the display device is configured to display the enlarged hazardous area. In particular, the open-loop and/or closed-loop control unit is configured to reduce the detection area on the basis of a reduction in the hazardous area, for example on account of a reduction in the rotational speed of the machining tool, and the display device is configured to display the reduced hazardous area. The hazardous area, in particular the boundaries of the hazardous area, can preferably correspond to the detection area, in particular the boundaries of the detection area. The open-loop and/or closed-loop control unit is preferably connected to the display device for signal transmission purposes, in particular for the purpose of providing at least one item of information relating to the change in the at least one parameter. In particular, the open-loop and/or closed-loop control unit may be connected to the display device, in particular to at least one communication unit of the display device, for signal transmission purposes via the communication unit of the machine tool device, in particular in a wireless manner. A system for visualizing the hazardous area that is comfortable and safe for an operator can be advantageously provided.

The machine tool device according to the invention, the machine tool according to the invention, the system according to the invention and/or the method according to the invention is/are not intended to be restricted here to the application and embodiment described above. In particular, the machine tool device according to the invention, the machine tool according to the invention, the system according to the invention and/or the method according to the invention may have a number of individual elements, components and units and method steps that differs from a number mentioned herein in order to perform a method of operation described herein. In addition, for the ranges of values stated in this disclosure, values which are also within the limits mentioned are intended to be considered to have been disclosed and to be usable in any desired manner.

### DRAWINGS

Further advantages emerge from the following description of the drawings. Five exemplary embodiments of the invention are illustrated in the drawings. The drawings, the description and the claims contain numerous features in combination. A person skilled in the art will also expediently consider the features individually and will combine them to form useful further combinations.

In the drawings:

FIG. 1 shows a schematic perspective illustration of a system according to the invention having a machine tool according to the invention and having a display device,

FIG. 2 shows a schematic perspective illustration of the machine tool according to the invention from FIG. 1,

FIG. 3 shows a further schematic perspective illustration of the machine tool according to the invention from FIG. 1,

FIG. 4 shows a schematic illustration of a detailed view of a part of the machine tool according to the invention from FIG. 1,

FIG. 5a shows a schematic illustration of a sectional view of a protective unit of a machine tool device according to the invention of the machine tool according to the invention from FIG. 1,

FIG. 5b shows a schematic illustration of a sectional view of a first alternative protective unit of the machine tool device according to the invention,

FIG. 5c shows a schematic illustration of a sectional view of a second alternative protective unit of the machine tool device according to the invention,

FIG. 5d shows a schematic illustration of a sectional view of a third alternative protective unit of the machine tool device according to the invention,

FIG. 5e shows a schematic illustration of a sectional view of a fourth alternative protective unit of the machine tool device according to the invention,

FIG. 5f shows a schematic illustration of a sectional view of a fifth alternative protective unit of the machine tool device according to the invention,

FIG. 6 shows a schematic illustration of a sectional view of a sliding plate of the machine tool device according to the invention,

FIG. 7a shows a schematic illustration of a plan view of the machine tool according to the invention from FIG. 1,

FIG. 7b shows a schematic illustration of a plan view of the machine tool according to the invention from FIG. 1 with a first alternative sensor unit,

FIG. 7c shows a schematic illustration of a plan view of the machine tool according to the invention from FIG. 1 with a second alternative sensor unit,

FIG. 7d shows a schematic illustration of a plan view of the machine tool according to the invention from FIG. 1 with a third alternative sensor unit,

FIG. 8 shows a schematic perspective illustration of a first alternative machine tool according to the invention,

FIG. 9 shows a circuit arrangement of a part of a sensor unit of a machine tool device according to the invention of the first alternative machine tool according to the invention,

FIG. 10 shows a schematic perspective illustration of a second alternative machine tool according to the invention,

FIG. 11 shows a schematic perspective illustration of a third alternative machine tool according to the invention, and

FIG. 12 shows a schematic perspective illustration of a fourth alternative machine tool according to the invention.

### DESCRIPTION OF THE EXEMPLARY EMBODIMENTS

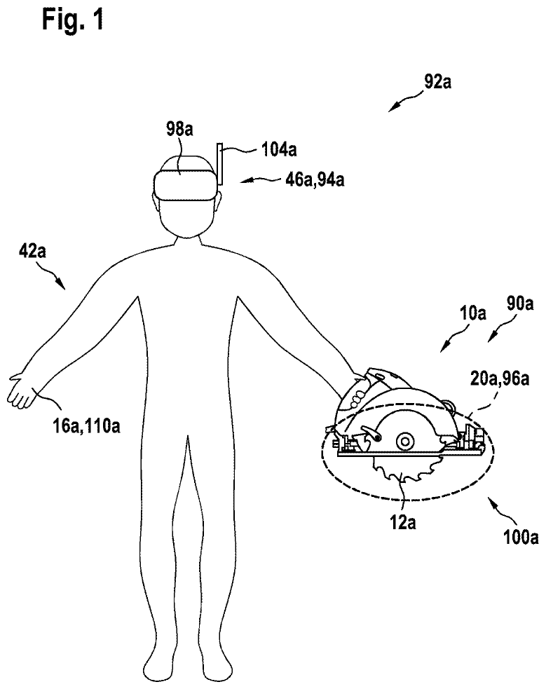

FIG. 1 shows a schematic perspective illustration of a system 92a having at least one machine tool 90a and having at least one display device 94a. The machine tool 90a preferably comprises at least one machine tool device 10a. The machine tool device 10a preferably comprises at least one machining tool 12a which can be driven by motor, at least one, in particular capacitive, sensor unit 14a which is configured to detect at least one foreign body 16a, 18a in at least one detection area 20a, 22a, 24a around the machining tool 12a, and at least one open-loop and/or closed-loop control unit 26a which is configured to trigger at least one action on the basis of at least one signal from the sensor unit 14a. The display device 94a is configured, in particular, to display at least one hazardous area 96a around at least one, in particular the above-mentioned, machining tool 12a of at least one, in particular the above-mentioned, machine tool device 10a of the machine tool 90a. In particular, the machine tool 90a which comprises the machine tool device 10a is in the form of a handheld machine tool. In particular, the machine tool 90a is in the form of a circular saw, in particular a handheld circular saw. In particular, the machining tool 12a is in the form of a saw blade, in particular a circular saw blade.

The display device 94a is preferably configured to adapt a display of the at least one hazardous area 96a on the basis of a change in at least one parameter, in particular on the basis of a change in at least one detection area 20a, 22a, 24a around the machining tool 12a. In the present exemplary embodiment, the sensor unit 14a has, by way of example, three detection areas 20a, 22a, 24a. For the sake of clarity, only one detection area 20a is illustrated in FIG. 1 and is described below. However, the description is also intended to similarly apply to the further detection areas 22a, 24a. The display device 94a may be arranged on the machine tool 90a, in particular, or, as in the present exemplary embodiment by way of example, may be formed separately from the machine tool 90a. The display device 94a is preferably in the form of an optical display device, in particular is configured to optically display the hazardous area 96a. In particular, the display device 94a has at least one illumination element, for example a light-emitting diode, a laser diode or the like, and/or a display element 98a, for example a screen, for displaying the hazardous area 96a. In the present exemplary embodiment, the display device 94a has, by way of example, a display element 98a in the form of a screen for displaying the hazardous area 96a. In particular, the display device 94a may be in the form of a projector, a smartphone, augmented reality glasses or another display device that appears to make sense to a person skilled in the art. In the present exemplary embodiment, the display device 94a is in the form of augmented reality glasses, for example. In particular, an operator 42a who is operating the machine tool 90a wears the display device 94a in front of his eyes. In particular, the display device 94a is configured to project, illuminate or the like the hazardous area 96a, in particular at least boundaries of the hazardous area 96a, around the machining tool 12a in a working area 100a and/or, as in the present exemplary embodiment for example, to display the hazardous area 96a, in particular at least the boundaries of the hazardous area 96a, in an image 102a, in particular a live image, of the machine tool 90a, for example in a signal color. In particular, the display device 94a may have at least one camera (not illustrated any further here) for recording the image, in particular the live image, of the machine tool 90a.

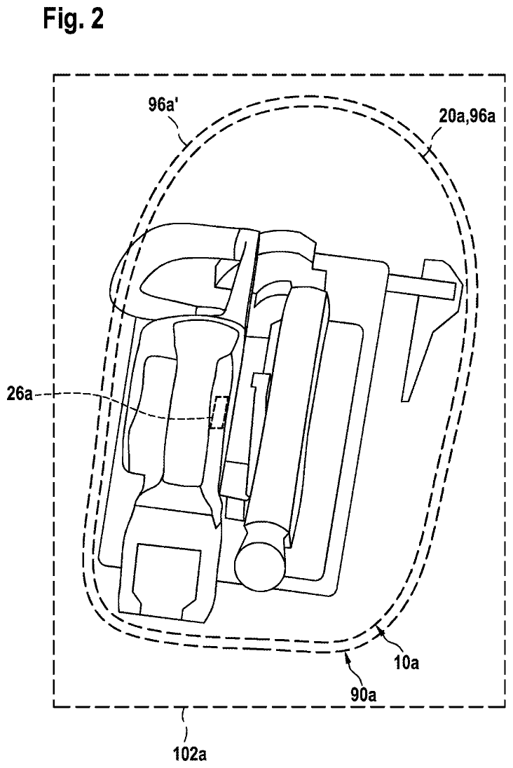

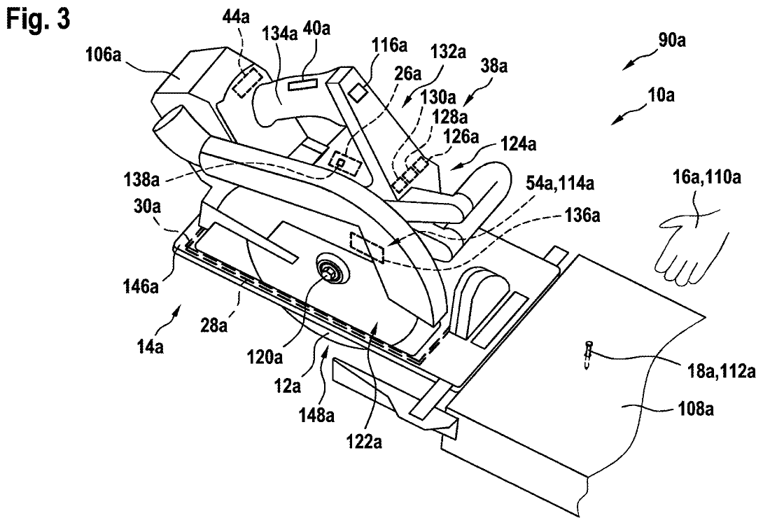

FIG. 2 shows a schematic perspective illustration of the machine tool 90a from FIG. 1. In particular, FIG. 2 illustrates the image 102a, in particular the live image, of the machine tool 90a with the hazardous area 96a displayed by the display device 94a. A change in the hazardous area 96a, in particular the boundaries of the hazardous area 96a, is preferably proportional to a change in the detection area 20a, in particular boundaries of the detection area 20a. In particular, the open-loop and/or closed-loop control unit 26a is configured to enlarge the detection area 20a on the basis of an enlargement of the hazardous area 96a, for example on account of an increase in a rotational speed of the machining tool 12a, and the display device 94a is configured to display the enlarged hazardous area 96a′. FIG. 2 illustrates, by way of example, the hazardous area 96a and an enlarged hazardous area 96a′. In particular, the open-loop and/or closed-loop control unit 26a is configured to reduce the detection area 20a on the basis of a reduction in the hazardous area 96a, for example on account of a reduction in the rotational speed of the machining tool 12a, and the display device 94a is configured to display the reduced hazardous area. As in the present exemplary embodiment for example, the hazardous area 96a, in particular the boundaries of the hazardous area 96a, can preferably correspond to the detection area 20a, in particular the boundaries of the detection area 20a. The open-loop and/or closed-loop control unit 26a is preferably connected to the display device 94a for signal transmission purposes, in particular for the purpose of providing at least one item of information relating to the change in the at least one parameter. In particular, the open-loop and/or closed-loop control unit 26a may be connected to the display device 94a, in particular to at least one communication unit 104a of the display device 94a, for signal transmission purposes via a communication unit 44a of the machine tool device 10a, in particular in a wireless manner (cf. FIGS. 1 and 3).

FIG. 3 shows a further schematic perspective illustration of the machine tool 90a from FIG. 1. The sensor unit 14a preferably comprises at least one antenna 28a, 30a which is configured to emit at least one electric and/or magnetic field, which defines the at least one detection area 20a, and/or to detect the at least one foreign body 16a, 18a on the basis of at least one change in at least one electric and/or magnetic field. In particular, the sensor unit 14a may have a plurality of antennas 28a, 30a, in particular for completely covering the machining tool 12a with a detection area 20a. In particular, the sensor unit 14a may have at least two antennas 28a, 30a, preferably at least four antennas 28a, 30a, particularly preferably at least six antennas 28a, 30a and very particularly preferably at least 8 antennas 28a, 30a. In the present exemplary embodiment, the sensor unit 14a has two antennas 28a, 30a for example.

The machine tool device 10a is preferably in the form of a handheld machine tool device. The machine tool device 10a is preferably in the form of an electrically operated machine tool device. In particular, the machine tool 90a is in the form of an electric machine tool. In particular, the machining tool 12a can be driven by at least one electric motor of the machine tool device 10a. The machine tool device 10a preferably comprises at least one electrical energy storage unit 106a, in particular a rechargeable battery, for supplying energy to at least the electric motor. Alternatively, it is conceivable for the machine tool device 10a to be in the form of a pneumatically operated machine tool device, a gasoline-operated machine tool device or the like. The machine tool device 10a is preferably provided for the purpose of cutting and/or sawing a workpiece 108a.

The sensor unit 14a is preferably in the form of an electrical and/or magnetic, in particular capacitive, sensor unit. In particular, the sensor unit 14a differs from an optical, acoustic, haptic sensor unit or the like. In particular, the sensor unit 14a is configured for proximity detection. The sensor unit 14a is preferably configured to detect the at least one foreign body 16a, 18a before contact with the machining tool 12a. FIG. 3 illustrates, by way of example, two foreign bodies 16a, 18a which can be detected by the sensor unit 14a. In particular, the sensor unit 14a is configured to detect the foreign bodies 16a, 18a at at least a particular distance from the machining tool 12a, in particular within the detection area 20a around the machining tool 12a. The detection area 20a is, in particular, an area which extends around the machining tool 12a and in which the sensor unit 14a is able and set up to detect the foreign bodies 16a, 18a. The detection area 20a preferably extends asymmetrically around the machining tool 12a (cf. FIG. 2). The detection area 20a preferably has a greater extent around points of the machining tool 12a that are dangerous to the operator 42a of the machine tool device 10a, in particular along a cutting edge of the machining tool 12a, than at other points of the machining tool 12a. Alternatively, it is conceivable for the detection area 20a to extend symmetrically, in particular spherically, around the machining tool 12a.

The foreign bodies 16a, 18a may be, in particular, in the form of animate objects, in particular body parts of the operator 42a, for example a hand 110a, a finger, a leg or the like, an animal or other animate objects that appear to make sense to a person skilled in the art. The foreign bodies 16a, 18a may be, in particular, in the form of inanimate objects, in particular disruptive objects which are arranged on the workpiece 108a and/or run in a vicinity of the workpiece 108a, for example a nail 112a, a power line, a water pipe or the like. In the present exemplary embodiment, one foreign body 16a, for example, is in the form of an animate object, in particular a hand 110a of the operator 42a, and a further foreign body 18a, for example, is in the form of an inanimate object, in particular a nail 112a arranged on the workpiece 108a.

The open-loop and/or closed-loop control unit 26a is preferably connected to the sensor unit 14a for signal transmission purposes, in particular via at least one signal line (not illustrated here). Alternatively or additionally, it is conceivable for the open-loop and/or closed-loop control unit 26a to be connected to the sensor unit 14a for signal transmission purposes via a wireless signal connection. The open-loop and/or closed-loop control unit 26a is preferably configured to actuate the sensor unit 14a. The sensor unit 14a is configured, in particular, to provide the open-loop and/or closed-loop control unit 26a with the at least one signal, preferably a plurality of signals, in particular on the basis of detection of at least one of the foreign bodies 16a, 18a in the detection area 20a. The open-loop and/or closed-loop control unit 26a is preferably configured to evaluate the at least one signal received from the sensor unit 14a. In particular, the open-loop and/or closed-loop control unit 26a is configured to trigger the at least one action on the basis of evaluation of the at least one signal from the sensor unit 14a.

The at least one action is preferably in the form of a safety function, in particular for preventing or at least minimizing injury to the operator 42a, and/or a comfort function, in particular for making it easier for the operator 42a to operate the machine tool device 10a. The at least one action may be, in particular, in the form of braking of the machining tool 12a, moving of the machining tool 12a out of the hazardous area 96a, shielding of the machining tool 12a, outputting of at least one, in particular optical, acoustic and/or haptic, warning message, making of an emergency call or another action that appears to make sense to a person skilled in the art. In particular, the open-loop and/or closed-loop control unit 26a may be configured to trigger a plurality of, in particular different, actions. The open-loop and/or closed-loop control unit 26a may preferably be configured to trigger different actions on the basis of different signals from the sensor unit 14a. In particular, the open-loop and/or closed-loop control unit 26a is configured to actuate at least one reaction unit 114a of the machine tool device 10a, which is provided for the purpose of performing the at least one action, on the basis of the at least one signal from the sensor unit 14a, in particular for the purpose of triggering the at least one action. The at least one reaction unit 114a may be, in particular, in the form of a braking unit 54a, a covering unit, a pivoting unit, a blocking unit, an output unit 116a, a communication unit 44a or another unit that appears to make sense to a person skilled in the art.

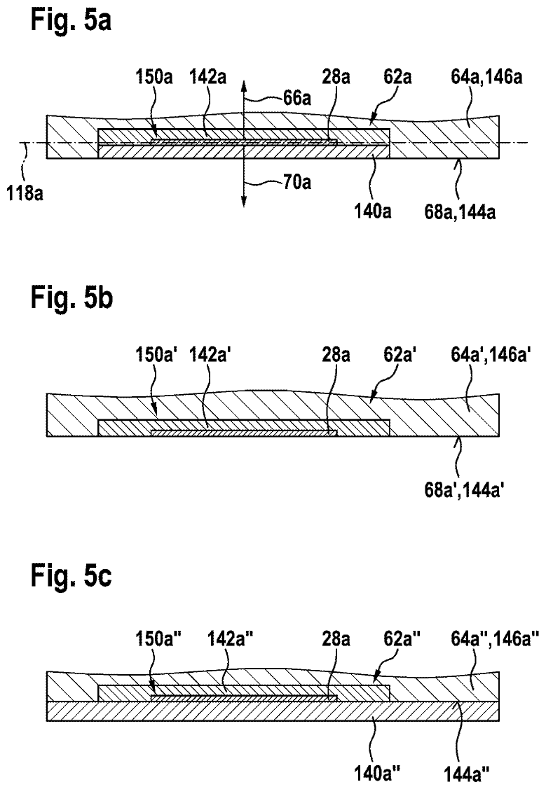

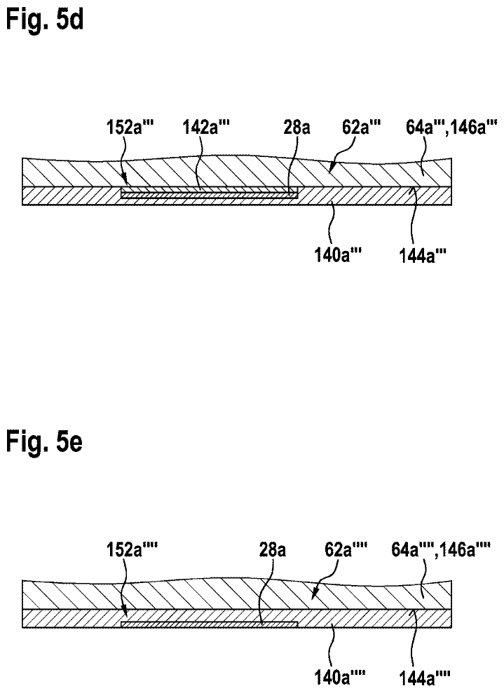

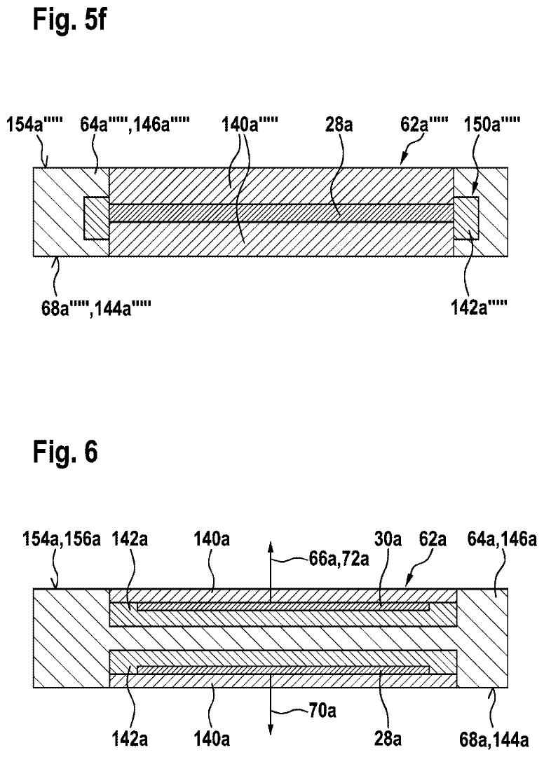

The antennas 28a, 30a are preferably configured to conduct electrical current. In particular, the antennas 28a, 30a are cylindrical, in particular circular-cylindrical. In particular, the antennas 28a, 30a are configured to emit an electric field distributed in a radially symmetrical manner about a longitudinal axis 118a of the antennas 28a, 30a and/or to emit a magnetic field distributed concentrically about the longitudinal axis 118a of the antennas 28a, 30a (cf. FIG. 5a). The antennas 28a, 30a are preferably in the form of cables, in particular coaxial cables, wires or the like. Alternatively or additionally, it is conceivable for the machining tool 12a and/or an output shaft 120a, on which the machining tool 12a is mounted, to form at least one antenna and/or for the antennas 28a, 30a to be configured to be electrically coupled to the machining tool 12a and/or to the output shaft 120a. The machining tool 12a is preferably in the form of an antenna, wherein the sensor unit 14a has at least one further antenna 28a, 30a which is formed separately from the machining tool 12a. In the present exemplary embodiment, the sensor unit 14a has, by way of example, the two antennas 28a, 30a which are formed separately from the machining tool 12a, in particular as coaxial cables. Alternatively or additionally, it is conceivable for at least one of the antennas 28a, 30a to be formed separately from the machine tool device 10a, in particular to be arranged on the operator 42a, for example on a glove or protective goggles belonging to the operator 42a.

In particular, the antennas 28a, 30a are configured to emit electromagnetic fields. In particular, the electric and/or magnetic, in particular electromagnetic, fields of the antennas 28a, 30a, in particular a field strength and/or a maximum extent of the electric and/or magnetic fields of the antennas 28a, 30a, are dependent on electrical voltages applied to the antennas 28a, 30a and/or on electrical currents flowing through the antennas 28a, 30a. In particular, the detection area 20a at least substantially has an identical shape to the electric, in particular electromagnetic, fields of the antennas 28a, 30a. The antennas 28a, 30a are preferably arranged in a vicinity 122a of the machining tool 12a.

The antennas 28a, 30a are preferably configured to detect the foreign bodies 16a, 18a on the basis of a change in the electric and/or magnetic fields emitted by the antennas 28a, 30a. Alternatively or additionally, it is conceivable for the antennas 28a, 30a to be configured to detect the foreign bodies 16a, 18a on the basis of a change in a further electric and/or magnetic field, in particular a field emitted by another antenna. In particular, a first antenna 28a may be configured to emit an electric and/or magnetic field and a second antenna 30a may be configured to detect the foreign bodies 16a, 18a on the basis of a change in the electric and/or magnetic field of the first antenna 28a. In particular, the foreign bodies 16a, 18a arranged in the detection area 20a change the electric and/or magnetic fields, in particular characteristic variables of the electric and/or magnetic fields, in particular on the basis of electrical and/or magnetic properties of the foreign bodies 16a, 18a. The antennas 28a, 30a are preferably configured to detect the foreign bodies 16a, 18a capacitively, in particular on the basis of a change in the capacitance of the electric and/or magnetic fields which is caused by the foreign bodies 16a, 18a. Alternatively or additionally, it is conceivable for the antennas 28a, 30a to be configured to detect the foreign bodies 16a, 18a inductively, in particular on the basis of a change in the inductance of the electric and/or magnetic fields which is caused by the foreign bodies 16a, 18a. The antennas 28a, 30a are preferably configured to detect a distance between the foreign bodies 16a, 18a and the machining tool 12a, in particular a position of the foreign bodies 16a, 18a at least relative to the machining tool 12a, a movement speed of the foreign bodies 16a, 18a, in particular a speed with which the foreign bodies 16a, 18a approach the machining tool 12a, and/or an acceleration of the foreign bodies 16a, 18a, in particular an acceleration with which the foreign bodies 16a, 18a approach the machining tool 12a.

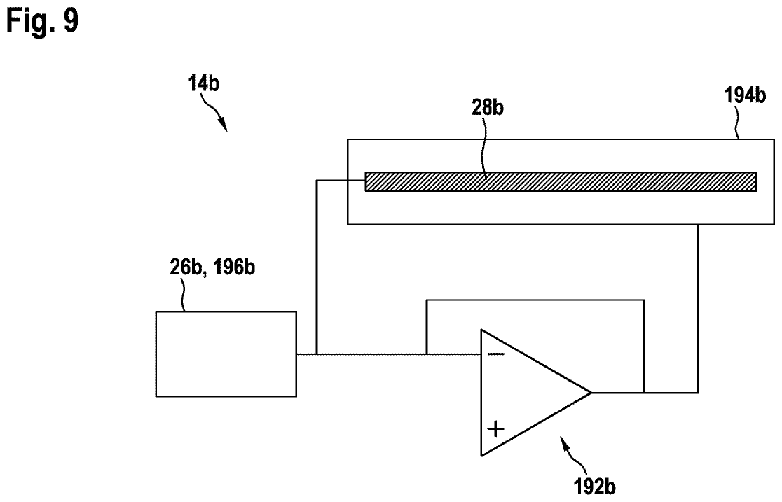

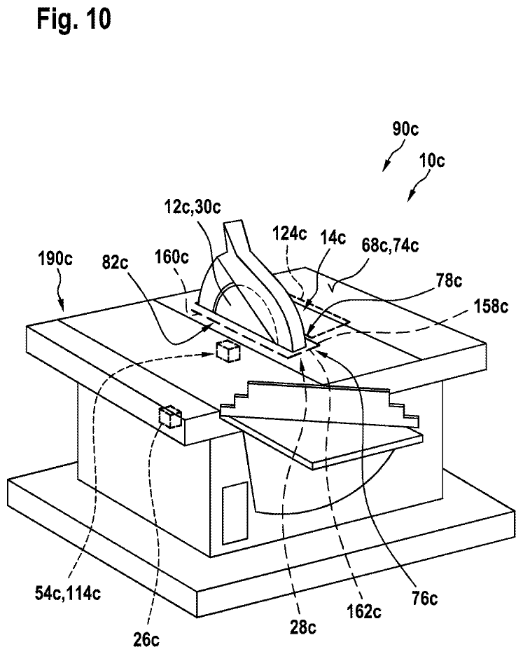

The sensor unit 14a preferably comprises at least one tuning circuit which is connected to at least one of the antennas 28a, 30a (not illustrated in any more detail, cf. 196b from FIG. 9). It is conceivable for a tuning circuit to be assigned to each of the antennas 28a, 30a. The tuning circuit is at least provided, in particular, for the purpose of generating an electric and/or magnetic field by interacting with at least one of the antennas 28a, 30a. The tuning circuit is preferably formed at least from a resonant circuit, in particular an RLC resonant circuit, and a phase stabilization circuit. An operating frequency of the tuning circuit is preferably less than 5 MHz. However, it is also alternatively conceivable for the operating frequency of the tuning circuit to be greater than 5 MHz. The tuning circuit has, in particular, at least one amplifier which is formed, for example, by a field effect transistor, a bipolar transistor, an operational amplifier or the like. Various amplifier topologies are also conceivable, for example a telescopic topology, a two-stage amplifier topology, a cascode topology or the like. The tuning circuit is preferably connected to a signal conditioning unit, in particular an analog/digital converter, wherein the signal conditioning unit can be connected at least to the open-loop and/or closed-loop control unit 26a for the purpose of transmitting signals. The signal conditioning unit preferably comprises at least one comparator, in particular a Schmitt trigger, which can be used to convert an analog signal, preferably from at least one of the antennas 28a, 30a, into a digital signal.

The open-loop and/or closed-loop control unit 26a is preferably configured to at least partially independently adapt at least one parameter on the basis of at least one operating parameter. The at least one operating parameter may be, in particular, in the form of a movement parameter, for example a movement speed of the machine tool device 10a, an orientation parameter, for example a spatial orientation of the machine tool device 10a, a machining parameter, for example a penetration depth of the machining tool 12a, an operator-specific parameter, for example a skin conductivity of the operator 42a, or another parameter that appears to make sense to a person skilled in the art. The at least one parameter to be adapted may be, in particular, in the form of a sensitivity of the sensor unit 14a, the detection area 20a, in particular the extent of the detection area 20a, the shape of the detection area 20a or the like, a type of the at least one action to be triggered, a sequence of a plurality of actions to be triggered, a triggering speed and/or a performance speed of the at least one action, for example a braking speed of the machining tool 12a, or another parameter that appears to make sense to a person skilled in the art.

The open-loop and/or closed-loop control unit 26a is preferably configured to evaluate the at least one operating parameter. The open-loop and/or closed-loop control unit 26a is preferably configured to at least partially independently adapt the at least one parameter on the basis of evaluation of the at least one operating parameter. The open-loop and/or closed-loop control unit 26a is preferably configured to adapt the at least one parameter in a completely independent manner, in particular automatically, for example on the basis of a comparison of the at least one operating parameter with open-loop control routines stored in a storage unit of the open-loop and/or closed-loop control unit 26a. Alternatively, it is conceivable for the open-loop and/or closed-loop control unit 26a to be configured to partially independently adapt the at least one parameter. In particular, the open-loop and/or closed-loop control unit 26a may be configured to provide the operator 42a with at least one recommendation for adapting the at least one parameter on the basis of the at least one operating parameter, in particular on the basis of the evaluation of the at least one operating parameter, for example via the output unit 116a of the machine tool device 10a, and to adapt the at least one parameter on the basis of an operator input. In the present exemplary embodiment, the machine tool device 10a has, by way of example, an acoustic output unit 116a in the form of a loudspeaker. The output unit 116a may also be alternatively or additionally in the form of an optical and/or haptic output unit. The open-loop and/or closed-loop control unit 26a may preferably be configured to at least partially independently adapt the at least one parameter, in particular a plurality of parameters, on the basis of a plurality of operating parameters. The open-loop and/or closed-loop control unit 26a may preferably be configured to at least partially independently adapt a plurality of parameters on the basis of the at least one operating parameter.

The open-loop and/or closed-loop control unit 26a is preferably configured to at least partially independently calibrate the sensor unit 14a, in particular to adapt the at least one detection area 20a, on the basis of the at least one operating parameter. In particular, the open-loop and/or closed-loop control unit 26a is configured to at least partially independently calibrate the sensor unit 14a as part of an operation of connecting the machine tool device 10a and/or on the basis of an operator input. The open-loop and/or closed-loop control unit 26a is preferably configured to calibrate the sensor unit 14a in a completely independent manner, in particular automatically, in particular to adapt the detection area 20a, on the basis of the at least one operating parameter, in particular on the basis of the evaluation of the at least one operating parameter. Alternatively, it is conceivable for the open-loop and/or closed-loop control unit 26a to be configured to partially independently calibrate the sensor unit 14a. In particular, the open-loop and/or closed-loop control unit 26a may be configured to provide the operator 42a with at least one recommendation for calibrating the sensor unit 14a on the basis of the at least one operating parameter, in particular on the basis of the evaluation of the at least one operating parameter, for example via the output unit 116a of the machine tool device 10a, and to calibrate the sensor unit 14a on the basis of an operator input.

In particular, the open-loop and/or closed-loop control unit 26a is configured, for the purpose of calibrating the sensor unit 14a, to at least partially independently adapt the detection area 20a of the sensor unit 14a, in particular the extent and/or the shape of the detection area 20a, on the basis of the at least one operating parameter, in particular on the basis of the evaluation of the at least one operating parameter. Alternatively or additionally, it is conceivable for the open-loop and/or closed-loop control unit 26a to be configured, for the purpose of calibrating the sensor unit 14a, to at least partially independently adapt the sensitivity of the sensor unit 14a, a reaction behavior of the sensor unit 14a to certain foreign bodies 16a, 18a, in particular to certain materials, or another parameter of the sensor unit 14a that appears to make sense to a person skilled in the art on the basis of the at least one operating parameter, in particular on the basis of the evaluation of the at least one operating parameter. For example, it is conceivable for the sensor unit 14a to be configured to detect an environment of the machine tool device 10a, in particular during an operation of connecting the machine tool device 10a, wherein the open-loop and/or closed-loop control unit 26a is configured to calibrate the sensor unit 14a on the basis of the detected environment. For example, it is conceivable for the sensor unit 14a to detect a body part of the operator 42a in the vicinity 122a of the machining tool 12a, which is arranged there for the purpose of guiding the machine tool 90a, wherein the open-loop and/or closed-loop control unit 26a reduces the detection area 20a and/or reduces a sensitivity of the sensor unit 14a, in particular for the purpose of reducing false triggering operations caused by the body part in the vicinity 122a of the machining tool 12a.

The at least one operating parameter is preferably in the form of a movement parameter and/or an orientation parameter. The at least one operating parameter in the form of a movement parameter may be, in particular, in the form of a movement speed of the machine tool device 10a, a movement acceleration of the machine tool device 10a, a direction of movement of the machine tool device 10a or another movement parameter that appears to make sense to a person skilled in the art. The at least one operating parameter in the form of an orientation parameter may be, in particular, in the form of a spatial orientation, in particular alignment, of the machine tool device 10a, in particular relative to the workpiece 108a, relative to a vertical axis of the machine tool device 10a, relative to a longitudinal axis of the machine tool device 10a and/or relative to a transverse axis of the machine tool device 10a. For example, it is conceivable for the open-loop and/or closed-loop control unit 26a to be configured to trigger faster braking operations as actions, the higher the detected movement speed of the machine tool device 10a. For example, it is conceivable for the open-loop and/or closed-loop control unit 26a to be configured to trigger the fastest possible braking as an action on the basis of a detected free fall of the machine tool device 10a.

The at least one operating parameter is preferably in the form of a machining parameter. The at least one operating parameter in the form of a machining parameter may be, in particular, in the form of a penetration depth of the machining tool 12a in the workpiece 108a, an inertia characteristic variable of the machining tool 12a, a workpiece condition, in particular a workpiece hardness, a workpiece thickness, a workpiece material, a workpiece moisture, kickback of the machine tool device 10a, a power consumption and/or a rotational speed of a motor 124a driving the machining tool 12a, a rotational speed of the machining tool 12a or the like or another machining parameter that appears to make sense to a person skilled in the art. For example, it is conceivable for the open-loop and/or closed-loop control unit 26a to be configured to set the detection area 20a to be larger, the deeper the detected penetration depth of the machining tool 12a.

The at least one operating parameter is preferably in the form of an operator-specific parameter. The at least one operating parameter in the form of an operator-specific parameter may be, in particular, in the form of a skin conductivity of the operator 42a, a method of operation typical of an operator, in particular an operating movement typical of an operator, operation of the machine tool device 10a that is typical of an operator, a degree of experience of the operator 42a or another operator-specific parameter that appears to make sense to a person skilled in the art. For example, it is conceivable for the open-loop and/or closed-loop control unit 26a to be configured to set the sensitivity of the sensor unit 14a to be lower, the greater the degree of experience of the operator 42a.

The machine tool device 10a preferably comprises at least one further sensor unit 38a which is configured to record the at least one operating parameter. The further sensor unit 38a preferably comprises at least one sensor element 40a, 126a, 128a, 130a for recording the at least one operating parameter. In particular, the sensor unit 38a may comprise a plurality of, in particular different, sensor elements 40a, 126a, 128a, 130a, in particular a number of different sensor elements 40a, 126a, 128a, 130a corresponding to a number of different operating parameters to be recorded. In the present exemplary embodiment, the further sensor unit 38a comprises, for example, four different sensor elements 40a, 126a, 128a, 130a, wherein a first sensor element 40a is configured, for example, to record an operating parameter in the form of an operator-specific parameter, wherein a second sensor element 126a is configured, for example, to record an operating parameter in the form of a movement parameter, wherein a third sensor element 128a is configured, for example, to record an operating parameter in the form of an orientation parameter, and wherein a fourth sensor element 130a is configured, for example, to record an operating parameter in the form of a machining parameter. The further sensor unit 38a is preferably configured to provide the open-loop and/or closed-loop control unit 26a with the at least one recorded operating parameter, in particular in the form of at least one electrical signal. Alternatively or additionally, it is conceivable for the sensor unit 14a, in particular the antennas 28a, 30a of the sensor unit 14a, to be configured to record at least certain operating parameters. In particular, the further sensor unit 38a has the second sensor element 126a in the form of an acceleration sensor for the purpose of recording the at least one operating parameter in the form of a movement parameter. In particular, the further sensor unit 38a has the third sensor element 128a, which is in the form of a position sensor, in particular a gyroscope, for the purpose of recording the at least one operating parameter in the form of an orientation parameter. In particular, the further sensor unit 38a may have at least one sensor element 130a, which is in the form of an optical sensor, a moisture sensor, an acceleration sensor, an inertial sensor, a temperature sensor, a current and/or voltage sensor, a rate-of-rotation sensor or the like, for the purpose of recording the at least one operating parameter in the form of a machining parameter. In the present exemplary embodiment, the further sensor unit 38a has the fourth sensor element 130a, which is in the form of a rate-of-rotation sensor, for the purpose of recording the at least one operating parameter in the form of a machining parameter. In particular, the further sensor unit 38a may have at least one sensor element 40a, which is in the form of a conductivity sensor, a fingerprint scanner, a facial scanner or the like, for the purpose of recording the at least one operating parameter in the form of an operator-specific parameter. In the present exemplary embodiment, the further sensor unit 38a has the first sensor element 40a, which is in the form of a conductivity sensor, for the purpose of recording the at least one operating parameter in the form of an operator-specific parameter.

The further sensor unit 38a, in particular the sensor elements 40a, 126a, 128a, 130a of the further sensor unit 38a, is/are preferably arranged on and/or in a housing unit 132a of the machine tool device 10a. Alternatively or additionally, it is conceivable for the further sensor unit 38a to be arranged separately from the housing unit 132a of the machine tool device 10a and to have, in particular, at least one, in particular wireless, communication unit for transmitting the at least one recorded operating parameter to the open-loop and/or closed-loop control unit 26a. The further sensor unit 38a is preferably configured to record the at least one operating parameter during operation of the machine tool device 10a, in particular continuously, and/or during an operation of connecting the machine tool device 10a. For example, it is conceivable for the further sensor unit 38a to be configured to record an operating parameter in the form of a mass inertia of the machining tool 12a while ramping up the rotational speed of the machining tool 12a to an operating rotational speed.

The further sensor unit 38a preferably has at least one, in particular the above-mentioned first, sensor element 40a which is configured to record at least one conductivity characteristic variable of at least one, in particular the above-mentioned, operator 42a. The first sensor element 40a is preferably in the form of a conductivity sensor. The conductivity characteristic variable describes, in particular, an ability to conduct electrical current. In particular, the conductivity characteristic variable is in the form of a skin conductivity of the operator 42a, in particular of at least one hand 110a of the operator 42a. The conductivity characteristic variable is preferably in the form of an operator-specific parameter. The first sensor element 40a is preferably arranged on at least one handle 134a of the machine tool device 10a. The open-loop and/or closed-loop control unit 26a is preferably configured to at least partially independently adapt the at least one parameter, in particular to calibrate the sensor unit 14a, on the basis of the recorded conductivity characteristic variable, in particular on the basis of evaluation of the recorded conductivity characteristic variable. In particular, different conductivity characteristic variables, for example of different operators 42a, hands 110a with different levels of moisture, hands 110a with different levels of heat, hands 110a with different levels of blood circulation or the like, cause different changes, in particular capacitance changes, in the electric and/or magnetic fields of the antennas 28a, 30a. The open-loop and/or closed-loop control unit 26a is preferably configured to calibrate the sensor unit 14a differently, in particular to set a sensitivity of the sensor unit 14a differently, on the basis of different conductivity characteristic variables. In particular, the open-loop and/or closed-loop control unit 26a is configured to set the sensitivity of the sensor unit 14a to be higher, the lower the conductivity characteristic variable, in particular the skin conductivity, of the operator 42a.

The machine tool device 10a preferably comprises at least one, in particular wireless, in particular the above-mentioned, communication unit 44a which is configured to receive the at least one operating parameter from at least one external unit 46a. The communication unit 44a of the machine tool device 10a is preferably in the form of a wireless communication unit, in particular a WLAN module, a radio module, a Bluetooth module, an NFC module or the like. Alternatively or additionally, it is conceivable for the communication unit 44a of the machine tool device 10a to be in the form of a wired communication unit, in particular a USB connection, an Ethernet connection, a coaxial connection or the like. The communication unit 44a of the machine tool device 10a is preferably connected to the open-loop and/or closed-loop control unit 26a for signal transmission purposes, in particular via at least one signal line (not illustrated any further here). In particular, the communication unit 44a of the machine tool device 10a is configured to provide the open-loop and/or closed-loop control unit 26a with the at least one operating parameter, in particular in the form of at least one electrical signal.

The external unit 46a may be, in particular, in the form of a smartphone, a server, in particular a cloud server and/or a database server, augmented reality glasses, a computer, an external sensor unit or another external unit that appears to make sense to a person skilled in the art. In the present exemplary embodiment, the external unit 46a is in the form of augmented reality glasses, for example. In particular, the external unit 46a is formed by the display device 94a (cf. FIG. 1). In particular, the external unit 46a is formed separately from the machine tool device 10a. The external unit 46a is preferably configured to record, store and/or obtain the at least one operating parameter, for example from a further sensor unit, a database, the Internet or another source that appears to make sense to a person skilled in the art. In particular, the external unit 46a comprises at least one, in particular the above-mentioned, communication unit 104a which is configured to transmit the at least one operating parameter to the machine tool device 10a, in particular to the communication unit 44a of the machine tool device 10a. The communication unit 104a of the external unit 46a may be designed, in particular, in an at least substantially similar manner to the communication unit 44a of the machine tool device 10a. The communication unit 44a of the machine tool device 10a may preferably be configured to provide the external unit 46a with identification data relating to the machine tool device 10a, wherein the external unit 46a can provide the machine tool device 10a, in particular, with at least one operating parameter matching the identification data.

The open-loop and/or closed-loop control unit 26a is preferably configured to trigger the at least one action on the basis of joint evaluation of the at least one signal from the sensor unit 14a and the at least one operating parameter. In particular, the open-loop and/or closed-loop control unit 26a is configured to evaluate, in particular weight, the at least one signal from the sensor unit 14a taking into account the at least one operating parameter and/or to evaluate, in particular weight, the at least one operating parameter taking into account the at least one signal from the sensor unit 14a. In particular, the open-loop and/or closed-loop control unit 26a may be configured to prevent the at least one action on the basis of the joint evaluation of the at least one signal from the sensor unit 14a and the at least one operating parameter. In particular, the open-loop and/or closed-loop control unit 26a may be configured to trigger the at least one action, in particular a plurality of actions, on the basis of joint evaluation of the at least one signal from the sensor unit 14a, in particular a plurality of signals from the sensor unit 14a, and the at least one operating parameter, in particular a plurality of operating parameters.

The open-loop and/or closed-loop control unit 26a is preferably configured to trigger different actions on the basis of different results of joint evaluations of the at least one signal from the sensor unit 14a and the at least one operating parameter. The open-loop and/or closed-loop control unit 26a is preferably configured to trigger the at least one action, which enables an optimum combination of operator safety and operator comfort, on the basis of the result of the joint evaluation of the at least one signal from the sensor unit 14a and the at least one operating parameter. For example, it is conceivable for the open-loop and/or closed-loop control unit 26a to be configured to trigger motor braking of the motor 124a driving the machining tool 12a on the basis of a low speed with which the foreign bodies 16a, 18a approach the machining tool 12a and a low mass inertia of the machining tool 12a, in particular for the purpose of braking the machining tool 12a to a standstill before being touched by the foreign bodies 16a, 18a with a simultaneously low mechanical load on the machining tool 12a. For example, it is conceivable for the open-loop and/or closed-loop control unit 26a to be configured to trigger mechanical braking of the machining tool 12a, on the basis of a higher speed with which the foreign bodies 16a, 18a approach the machining tool 12a and/or a higher mass inertia of the machining tool 12a, in addition to the motor braking of the motor 124a driving the machining tool 12a, which, in the present situation, would not be able, in particular, to brake the machining tool 12a to a standstill before contact of the foreign bodies 16a, 18a with the machining tool 12a. In particular, actions to be respectively triggered are assigned to a plurality of possible results, preferably each possible result, of joint evaluations of the at least one signal from the sensor unit 14a and the at least one operating parameter in the storage unit of the open-loop and/or closed-loop control unit 26a. The open-loop and/or closed-loop control unit 26a is preferably configured to trigger the at least one action assigned to the respective result of the evaluation.

The open-loop and/or closed-loop control unit 26a is preferably configured to classify different foreign bodies 16a, 18a detected by the sensor unit 14a and to trigger different actions on the basis of different classifications. In particular, the open-loop and/or closed-loop control unit 26a is configured to distinguish, for example, between different types of foreign bodies 16a, 18a, for example between the foreign body 16a and the further foreign body 18a in the present exemplary embodiment, on the basis of different signals from the sensor unit 14a. In particular, different types of foreign bodies 16a, 18a have different electrical and/or magnetic, in particular capacitive, properties, in particular influence the electric and/or magnetic fields of the antennas 28a, 30a differently. In particular, each type of foreign body 16a, 18a has its own electrical and/or magnetic, in particular capacitive, signature. The open-loop and/or closed-loop control unit 26a is preferably configured to identify a type of the foreign body 16a, 18a on the basis of the electrical and/or magnetic, in particular capacitive, signature of the foreign body 16a, 18a and to classify the foreign body 16a, 18a. Electrical and/or magnetic, in particular capacitive, signatures of various types of foreign bodies 16a, 18a are preferably stored in the storage unit of the open-loop and/or closed-loop control unit 26a. In particular, the open-loop and/or closed-loop control unit 26a is configured to compare a signal from the sensor unit 14a corresponding to detection of a foreign body 16a, 18a with the stored signatures and to classify the foreign body 16a, 18a on the basis of the comparison.

In particular, the open-loop and/or closed-loop control unit 26a is configured to distinguish between animate and inanimate foreign bodies 16a, 18a on the basis of different signals from the sensor unit 14a and to classify the foreign bodies 16a, 18a accordingly. The open-loop and/or closed-loop control unit 26a is preferably configured to distinguish between human and animal animate foreign bodies 16a on the basis of different signals from the sensor unit 14a and to classify the foreign bodies 16a accordingly. In the present exemplary embodiment, the open-loop and/or closed-loop control unit 26a is configured, for example, to classify the hand 110a of the operator 42a as the human animate foreign body 16a. The open-loop and/or closed-loop control unit 26a is preferably configured to distinguish between inanimate foreign bodies 18a of different materials on the basis of different signals from the sensor unit 14a and to classify the foreign bodies 18a accordingly. In the present exemplary embodiment, the open-loop and/or closed-loop control unit 26a is configured, for example, to classify the nail 112a as the inanimate foreign body 18a made from a metal. Different actions to be triggered are preferably stored in the storage unit of the open-loop and/or closed-loop control unit 26a in a manner assigned to different classifications of foreign bodies 16a, 18a. In particular, the open-loop and/or closed-loop control unit 26a is configured to trigger at least one action assigned to a classification of a detected foreign body 16a, 18a. For example, it is conceivable for the open-loop and/or closed-loop control unit 26a to be configured to trigger pivoting of the machining tool 12a out of the hazardous area 96a on the basis of the detected further foreign body 18a which is classified as an inanimate foreign body 18a and to trigger mechanical braking of the machining tool 12a on the basis of the detected foreign body 16a which is classified as an animate foreign body 16a.

The machine tool device 10a preferably comprises at least one, in particular the above-mentioned, mechanical braking unit 54a which is provided for the purpose of braking the machining tool 12a, wherein the open-loop and/or closed-loop control unit 26a is configured to use at least one electrical current of a motor braking operation to actuate the mechanical braking unit 54a. The mechanical braking unit 54a is preferably provided for the purpose of mechanically braking the, in particular moving, in particular rotating, machining tool 12a, in particular until the machining tool 12a comes to a standstill. The mechanical braking unit 54a is preferably provided for the purpose of actively braking the machining tool 12a, in particular by establishing a force fit and/or form fit with the machining tool 12a and/or with the output shaft 120a, on which the machining tool 12a is mounted. In particular, the mechanical braking unit 54a comprises at least one mechanical braking element 136a, in particular, as in the present exemplary embodiment for example, a brake shoe, a wrap spring, a blocking pin or the like, which can be coupled to the machining tool 12a and/or to the output shaft 120a in a force-fitting and/or form-fitting manner in order to actively brake the machining tool 12a. Alternatively or additionally, it is conceivable for the mechanical braking unit 54a to be provided for the purpose of passively braking the machining tool 12a, in particular by decoupling the machining tool 12a from the motor 124a driving the machining tool 12a. The mechanical braking unit 54a is preferably provided for the purpose of braking the machining tool 12a until the machining tool 12a comes to a standstill, at the latest 200 milliseconds after the mechanical braking has been triggered. The mechanical braking unit 54a is preferably provided for the purpose of braking the machining tool 12a with such a braking force that the machining tool 12a at least temporarily slides relative to the output shaft 120a, in particular moves more quickly than the output shaft 120a, during braking.

The open-loop and/or closed-loop control unit 26a is preferably configured to carry out the motor braking, in particular to actuate the motor 124a driving the machining tool 12a perform a braking operation. In particular, the open-loop and/or closed-loop control unit 26a may be configured to carry out motor braking operations of different severity on the basis of different power consumptions of the motor 124a. In particular, the open-loop and/or closed-loop control unit 26a is configured to switch off, short-circuit, reverse the polarity of or similarly act on the motor 124a driving the machining tool 12a, in particular an electric motor, in order to achieve a motor braking operation. In particular, at least one electrical current, in particular a greater electrical current than during normal operation of the motor 124a, flows during motor braking. The open-loop and/or closed-loop control unit 26a is preferably configured to use the at least one electrical current of the motor braking to actuate at least one triggering unit 138a, in particular to conduct the at least one electrical current of the motor braking to the triggering unit 138a. In particular, the open-loop and/or closed-loop control unit 26a, as in the present exemplary embodiment for example, or the mechanical braking unit 54a comprises the triggering unit 138a. The triggering unit 138a is preferably provided for the purpose of releasing the at least one mechanical braking element 136a and/or at least one braking actuator of the mechanical braking unit 54a. The triggering unit 138a may be, in particular, in the form of a shape memory metal, as in the present exemplary embodiment for example, a relay, an electromagnet, a fuse wire or another triggering unit that appears to make sense to a person skilled in the art. In particular, the at least one electrical current of the motor braking may deform the triggering unit 138a in the form of a shape memory metal or may switch an alternative triggering unit in the form of a relay or an electromagnet and/or may fuse an alternative triggering unit in the form of a fuse wire.

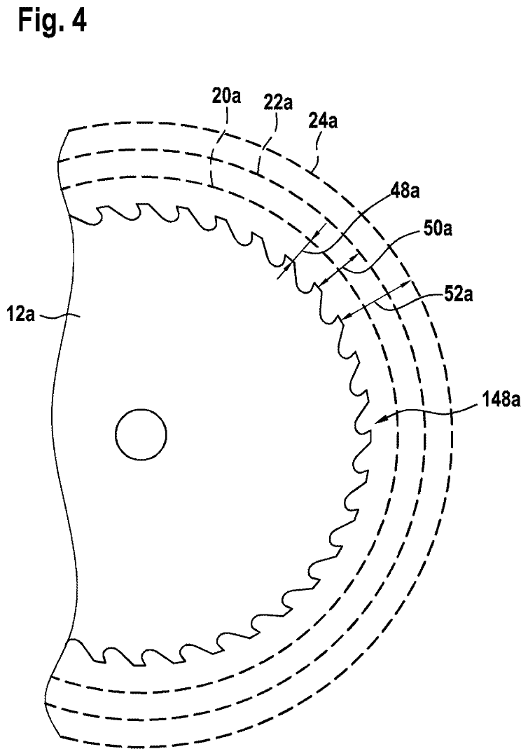

FIG. 4 shows a schematic illustration of a detailed view of a part of the machine tool 90a from FIG. 1, in particular the machining tool 12a. The sensor unit 14a is preferably configured to provide a plurality of detection areas 20a, 22a, 24a of different radii 48a, 50a, 52a around the machining tool 12a. The antennas 28a, 30a are preferably configured to provide the plurality of detection areas 20a, 22a, 24a of different radii 48a, 50a, 52a around the machining tool 12a. Alternatively or additionally, it is conceivable for the sensor unit 14a to comprise a plurality of antennas 28a, 30a, in particular a number of antennas 28a, 30a corresponding to a number of detection areas 20a, 22a, 24a to be provided, wherein a respective antenna 28a, 30a, in particular, is configured to provide at least one of the plurality of detection areas 20a, 22a, 24a. In the present exemplary embodiment, the sensor unit 14a is configured, for example, to provide a first detection area 24a in a first radius 52a around the machining tool 12a, a second detection area 22a in a second radius 50a around the machining tool 12a and a third detection area 20a in a third radius 48a around the machining tool 12a. The detection areas 20a, 22a, 24a are preferably in the form of layers or shells, in particular cylindrical shells, spherical shells or the like. In particular, the detection areas 20a, 22a, 24a have equidistant extents between one another, as seen along the radii 48a, 50a, 52a of the detection areas 20a, 22a, 24a. Alternatively, it is conceivable for the detection areas 20a, 22a, 24a to have differing extents between one another, as seen along the radii 48a, 50a, 52a of the detection areas 20a, 22a, 24a.

The open-loop and/or closed-loop control unit 26a is preferably configured to determine a distance between the foreign bodies 16a, 18a and the machining tool 12a on the basis of detection of the foreign bodies 16a, 18a in a particular detection area 20a, 22a, 24a. In particular, the open-loop and/or closed-loop control unit 26a is configured to determine the movement speeds of the foreign bodies 16a, 18a, in particular the speeds with which the foreign bodies 16a, 18a approach the machining tool 12a, on the basis of a period of time that has elapsed between operations of detecting the foreign bodies 16a, 18a in two different detection areas 20a, 22a, 24a, in particular detection areas adjoining one another, and on the basis of extents of the detection areas 20a, 22a, 24a. The open-loop and/or closed-loop control unit 26a is preferably configured to determine the movement accelerations of the foreign bodies 16a, 18a, in particular the accelerations with which the foreign bodies 16a, 18a approach the machining tool 12a, on the basis of different determined movement speeds of the foreign bodies 16a, 18a in different detection areas 20a, 22a, 24a.

The open-loop and/or closed-loop control unit 26a is preferably configured to trigger different actions, in particular in a cascaded manner, on the basis of different signals from the sensor unit 14a corresponding to detections of the at least one foreign body 16a, 18a in different detection areas 20a, 22a, 24a. In particular, the open-loop and/or closed-loop control unit 26a is configured to trigger different actions, in particular in a cascaded manner, on the basis of different distances between the foreign bodies 16a, 18a and the machining tool 12a. In particular, it is conceivable for the open-loop and/or closed-loop control unit 26a to be configured to trigger an output of a warning signal on the basis of a signal from the sensor unit 14a corresponding to detection of the foreign bodies 16a, 18a in the first detection area 24a at a maximum distance from the machining tool 12a. In particular, it is conceivable for the open-loop and/or closed-loop control unit 26a to be configured to trigger switching-off of the motor 124a driving the machining tool 12a on the basis of a signal from the sensor unit 14a corresponding to detection of the foreign bodies 16a, 18a in the second detection area 22a at a shorter distance from the machining tool 12a than the first detection area 24a. In particular, it is conceivable for the open-loop and/or closed-loop control unit 26a to be configured to trigger mechanical braking of the machining tool 12a on the basis of a signal from the sensor unit 14a corresponding to detection of the foreign bodies 16a, 18a in the third detection area 20a at a shorter distance from the machining tool 12a than the second detection area 22a. The open-loop and/or closed-loop control unit 26a is preferably configured to trigger a plurality of different actions, in particular in a cascaded manner, on the basis of a plurality of successive different signals from the sensor unit 14a corresponding to a movement of the foreign bodies 16a, 18a through different detection areas 20a, 22a, 24a. In particular, it is conceivable for the open-loop and/or closed-loop control unit 26a to trigger the output of the warning signal, the switching-off of the motor 124a driving the machining tool 12a and the mechanical braking of the machining tool 12a in a cascaded manner on the basis of a plurality of successive different signals from the sensor unit 14a corresponding to a movement of the foreign bodies 16a, 18a into the first detection area 24a, from the first detection area 24a into the second detection area 22a and from the second detection area 22a into the third detection area 20a.

FIG. 5a shows a schematic illustration of a sectional view of a protective unit 62a of the machine tool device 10a of the machine tool 90a from FIG. 1. The machine tool device 10a preferably comprises at least one, in particular the above-mentioned, protective unit 62a which surrounds the at least one antenna 28a, 30a at least in sections and is provided for the purpose of protecting the at least one antenna 28a, 30a from environmental influences. For the sake of clarity, only the antenna 28a is illustrated in FIG. 5a and in the subsequent FIGS. 5b to 5f, which is why only the antenna 28a is also described in the following description. However, the description similarly also applies to the further antenna 30a (cf. also FIG. 6). The at least one protective unit 62a is preferably provided for the purpose of protecting the at least one antenna 28a from mechanical environmental influences, in particular shocks, vibrations, abrasion or the like. In particular, the at least one protective unit 62a may be at least partially formed from an at least partially shock-absorbing and/or abrasion-resistant material, for example from a rubber, a silicone or the like. The protective unit 62a is preferably formed from an electrically insulating material. In particular, impact protection 140a of the machine tool device 10a may form the at least one protective unit 62a at least in sections. In particular, the at least one antenna 28a may be integrated, at least in sections, into the impact protection 140a of the machine tool device 10a. In the present exemplary embodiment, the antenna 28a is surrounded, for example, by the impact protection 140a of the machine tool device 10a and by an additional material layer 142a of the protective unit 62a. In particular, the impact protection 140a forms, at least in sections, an outer side 144a, in particular a workpiece support surface 68a, of a sliding plate 146a of the machine tool device 10a, on which, in particular inside which, at least in sections, the protective unit 62a and the antenna 28a are arranged. In particular, the additional material layer 142a of the protective unit 62a is arranged inside the sliding plate 146a, in particular shields the antenna 28a with respect to the sliding plate 146a. The at least one protective unit 62a is preferably provided for the purpose of protecting the at least one antenna 28a from weather-related and/or environment-related environmental influences, in particular moisture, frost, heat or the like. In particular, the at least one protective unit 62a may be at least partially formed from an at least partially fluid-tight, in particular watertight, and/or thermally insulating material. The at least one protective unit 62a preferably surrounds the at least one antenna 28a completely, in particular as seen along any desired spatial direction. Alternatively, it is conceivable for the at least one protective unit 62a to surround the at least one antenna 28a in sections, for example at least on a workpiece support surface 68a. The at least one protective unit 62a is preferably molded onto the at least one antenna 28a and/or onto at least one shielding unit 64a of the machine tool device 10a at least in sections, in particular injection molded around the at least one antenna 28a and/or the at least one shielding unit 64a. Alternatively, it is conceivable for the at least one antenna 28a and/or the at least one shielding unit 64a to be inserted, clamped, adhesively bonded, welded, soldered or the like at least in sections into the at least one protective unit 62a. The machine tool device 10a may preferably have a plurality of protective units 62a, in particular a number of protective units 62a corresponding to a number of antennas 28a, 30a. Alternatively, as in the present exemplary embodiment for example, or additionally, it is conceivable for an individual protective unit 62a to be provided for the purpose of receiving a plurality of antennas 28a, 30a, in particular surrounding them at least in sections (cf. FIG. 6).

The machine tool device 10a preferably comprises at least one, in particular the at least one above-mentioned, shielding unit 64a which surrounds the at least one antenna 28a, 30a at least in sections and is provided for the purpose of shielding at least one electric and/or magnetic field of the at least one antenna 28a, 30a, which defines the at least one detection area 20a, 22a, 24a, along at least one emission direction 66a, 70a. The at least one shielding unit 64a is preferably formed from a material that is not transparent to electromagnetic radiation, in particular electric and/or magnetic fields, in particular from a metal, for example from a lead, an iron, a steel or the like. In particular, the at least one shielding unit 64a is provided for the purpose of absorbing and/or reflecting the electric and/or magnetic field of the at least one antenna 28a along the at least one emission direction 66a. It is additionally conceivable for the at least one shielding unit 64a to be configured to focus the electric and/or magnetic field of the at least one antenna 28a along at least one emission direction 70a without shielding. The at least one shielding unit 64a preferably surrounds the at least one antenna 28a in sections. In particular, the at least one antenna 28a is arranged without shielding, as seen along at least one emission direction 70a, in particular along a further emission direction 70a, along which the shielding unit 64a shields the electric and/or magnetic field of the further antenna 30a (cf. FIG. 6). In particular, at least one hazardous area 148a of the machining tool 12a, for example a cutting edge of the machining tool 12a, is arranged (not illustrated here) along the at least one further emission direction 70a, along which the at least one antenna 28a is arranged without shielding.

In particular, the at least one shielding unit 64a can surround the at least one protective unit 62a at least in sections, as in the present exemplary embodiment in particular, and/or the at least one protective unit 62a can surround the at least one shielding unit 64a at least in sections. In particular, the at least one protective unit 62a may be integrated, at least in sections, into the at least one shielding unit 64a, as in the present exemplary embodiment for example, and/or the at least one shielding unit 64a may be integrated, at least in sections, into the at least one protective unit 62a. The at least one protective unit 62a and the at least one shielding unit 64a may preferably have a one-piece design in an alternative embodiment. In particular, in the alternative embodiment, the machine tool device 10a may have at least one combined protective and shielding unit. The at least one shielding unit 64a is preferably molded onto the at least one antenna 28a and/or onto the at least one protective unit 62a at least in sections, in particular injection molded around the at least one antenna 28a and/or the at least one protective unit 62a. Alternatively, it is conceivable, as in the present exemplary embodiment in particular, for the at least one antenna 28a and/or the at least one protective unit 62a to be inserted, clamped, adhesively bonded, welded, soldered or the like at least in sections into the at least one shielding unit 64a. The machine tool device 10a may preferably have a plurality of shielding units 64a, in particular a number of shielding units 64a corresponding to a number of antennas 28a, 30a. Alternatively or additionally, it is conceivable, as in the present exemplary embodiment for example, for an individual shielding unit 64a to be provided for the purpose of receiving a plurality of antennas 28a, 30a, in particular surrounding them at least in sections (cf. FIG. 6). The at least one shielding unit 64a is preferably formed, at least in sections, by a table, a base plate, the sliding plate 146a or the like of the machine tool device 10a. In the present exemplary embodiment, the shielding unit 64a is formed, for example, by the sliding plate 146a of the machine tool device 10a. In particular, the antenna 28a and the protective unit 62a are arranged, at least in sections, in a recess 150a of the sliding plate 146a.

FIG. 5b shows a schematic illustration of a sectional view of a first alternative protective unit 62a′ of the machine tool device 10a. Apart from the impact protection 140a, the protective unit 62a′ has a similar design to the protective unit 62a shown in FIG. 5a. In particular, the protective unit 62a′ is free from impact protection. An antenna 28a preferably terminates flush with an outer side 144a′ of a sliding plate 146a′. The protective unit 62a′ preferably comprises a material layer 142a′ which surrounds the antenna 28a at least in sections.

FIG. 5c shows a schematic illustration of a sectional view of a second alternative protective unit 62a″ of the machine tool device 10a. The protective unit 62a″ comprises, in particular, impact protection 140a″ which extends beyond a recess 150a″ of the sliding plate 146a″ on an outer side 144a″ of a sliding plate 146a″, in particular covers the entire outer side 144a″ of the sliding plate 146a″.

FIG. 5d shows a schematic illustration of a sectional view of a third alternative protective unit 62a′″ of the machine tool device 10a. The protective unit 62a′″ comprises, in particular, impact protection 140a′″ which surrounds an antenna 28a along a plurality of sides, in particular along more sides than an additional material layer 142a′″ of the protective unit 62a′″. A sliding plate 146a′″ is free from a recess. In particular, the impact protection 140a′″ has a recess 152a′″ for receiving the antenna 28a and the additional material layer 142a′″. In particular, the recess 152a′″ faces the sliding plate 146a′″, in particular is covered by the sliding plate 146a′″.

FIG. 5e shows a schematic illustration of a sectional view of a fourth alternative protective unit 62a″″ of the machine tool device 10a. The protective unit 62a″″ comprises, in particular, impact protection 140a″″ which surrounds an antenna 28a along a plurality of sides. In particular, the protective unit 62a″″ is free from an additional material layer. A sliding plate 146a″″ is free from a recess. In particular, the impact protection 140a″″ has a recess 152a″″ for receiving the antenna 28a. In particular, the recess 152a″″ faces away from the sliding plate 146a″″. In particular, the antenna 28a terminates flush with the impact protection 140a″″.

FIG. 5f shows a schematic illustration of a sectional view of a fifth alternative protective unit 62a′″″ of the machine tool device 10a. The protective unit 62a′″″ comprises impact protection 140a′″″ which surrounds an antenna 28a on at least two sides facing away from one another. In particular, the impact protection 140a′″″ terminates flush with two outer sides 144a′″″, 154a′″″ of a sliding plate 146a′″″ which face away from one another. An additional material layer 142a′″″ of the protective unit 62a′″″ and, at least in sections, the impact protection 140a′″″ are arranged in a recess 150a′″″ of the sliding plate 146a′″″.

FIG. 6 shows a schematic illustration of a sectional view of the sliding plate 146a of the machine tool device 10a. The machine tool device 10a preferably comprises at least one, in particular the above-mentioned, workpiece support surface 68a, wherein the sensor unit 14a comprises at least one, in particular the above-mentioned, further antenna 30a which has at least one emission direction 72a running anti-parallel to at least one, in particular the above-mentioned further, emission direction 70a of the at least one antenna 28a and transversely, in particular perpendicularly, to the workpiece support surface 68a. In particular, the table of the machine tool device 10a, the base plate of the machine tool device 10a, the sliding plate 146a of the machine tool device 10a or another component of the machine tool device 10a that appears to make sense to a person skilled in the art can comprise the workpiece support surface 68a. In the present exemplary embodiment, the sliding plate 146a comprises the workpiece support surface 68a, for example. In particular, the outer side 144a of the sliding plate 146a forms the workpiece support surface 68a. In particular, the at least two antennas 28a, 30a are arranged on sides of the sliding plate 146a which face away from one another. The at least one further antenna 30a is preferably arranged on a further surface 156a of the machine tool device 10a that faces away from the workpiece support surface 68a, in particular on the further outer side 154a of the sliding plate 146a, and the at least one antenna 28a is arranged on the workpiece support surface 68a. In particular, the workpiece support surface 68a and the further surface 156a extend parallel to one another. In particular, the at least one antenna 28a and the at least one further antenna 30a extend parallel to one another.

The at least one antenna 28a preferably has a plurality of emission directions 70a which run transversely to a respective emission direction 72a of the at least one further antenna 30a. In particular, the at least one emission direction 70a, preferably each emission direction 70a, of the at least one antenna 28a points away from the at least one further antenna 30a. In particular, the at least one shielding unit 64a shields the electric and/or magnetic field of the at least one antenna 28a at least along a direction pointing toward the at least one further antenna 28a. In particular, the at least one emission direction 72a, preferably each emission direction 72a, of the at least one further antenna 30a points away from the at least one antenna 28a. In particular, the shielding unit 64a of the machine tool device 10a shields the electric and/or magnetic field of the at least one further antenna 30a at least along a direction pointing toward the at least one antenna 28a. The machining tool 12a preferably extends, in at least one operating state, at least in sections, through the workpiece support surface 68a and/or through the further surface 156a, in particular through the sliding plate 146a that has the workpiece support surface 68a and the further surface 156a (cf. FIG. 3). A detection area 20a defined by the electric and/or magnetic field of the at least one antenna 28a preferably covers a hazardous area 148a, in particular a cutting edge, of the machining tool 12a that is arranged on the side of the workpiece support surface 68a, and a detection area 20a defined by the electric and/or magnetic field of the at least one further antenna 30a covers a hazardous area 148a, in particular the cutting edge, of the machining tool 12a that is arranged on the side of the further surface 156a.

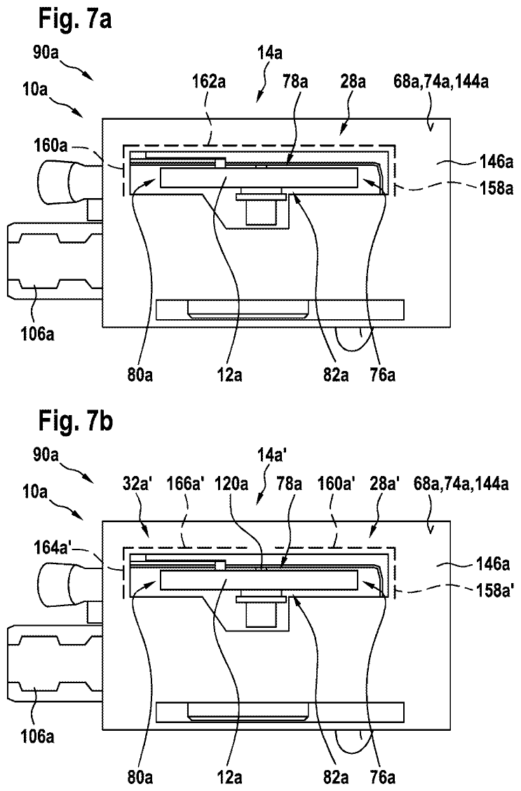

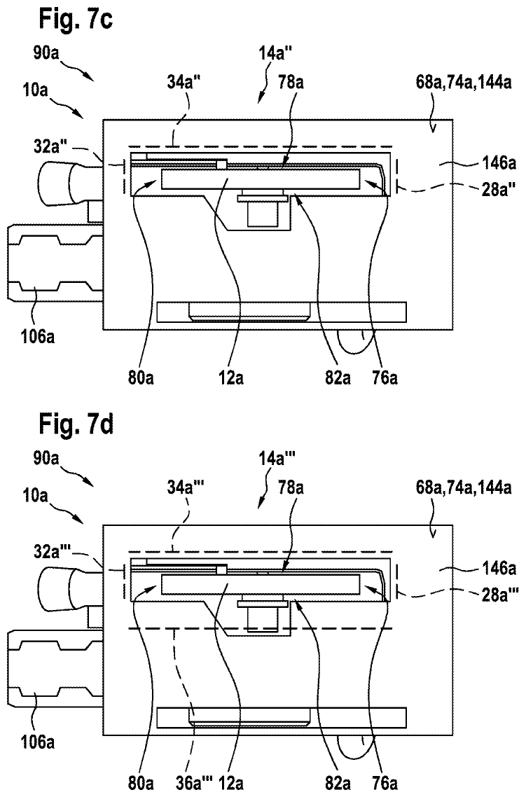

FIG. 7a shows a schematic illustration of a plan view of the machine tool 90a from FIG. 1, in particular the workpiece support surface 68a. The at least one antenna 28a, 30a preferably has a non-linear profile and surrounds the machining tool 12a, as seen in at least one plane 74a, along at least two sides 76a, 78a, 80a. In particular, the antenna 28a and the further antenna 30a have a non-linear profile and surround the machining tool 12a, in at least two planes 74a extending parallel to one another, along at least two sides 76a, 78a, 80a. On account of the type of illustration, only the antenna 28a can be seen in FIG. 7a and is described below, in particular also with respect to FIGS. 7b to 7d. However, on account of the parallel course to the antenna 28a, the description also applies to the further antenna 30a. The at least one antenna 28a preferably surrounds the machining tool 12a, as seen at least in a plane 74a parallel to the workpiece support surface 68a, in particular in the workpiece support surface 68a, along at least two sides 76a, 78a, 80a. In particular, the at least one antenna 28a surrounds the machining tool 12a, as seen in the at least one plane 74a, along at least two sides 76a, 78a, 80a, preferably along at least three sides 76a, 78a, 80a and particularly preferably along four sides 76a, 78a, 80a. In the present exemplary embodiment, the antenna 28a surrounds the machining tool 12a, as seen in the plane 74a, along three sides 76a, 78a, 80a, for example. In particular, the machining tool 12a has, as seen in the at least one plane 74a, two hazardous sides, in particular cutting edge sides, and two blade sides. In particular, a first side 76a and a third side 80a, along which the antenna 28a surrounds the machining tool 12a as seen in the plane 74a, are in the form of the two hazardous sides, in particular cutting edge sides. In particular, a second side 78a, along which the antenna 28a surrounds the machining tool 12a as seen in the plane 74a, is in the form of a blade side. The at least one antenna 28a preferably surrounds the machining tool 12a, as seen in the at least one plane 74a, along at least one hazardous side and along at least one blade side. In the present exemplary embodiment, the antenna 28a surrounds the machining tool 12a, as seen in the plane 74a, along both hazardous sides and along one blade side, for example. The at least one antenna 28a preferably describes, at least in sections, at least one curve, at least one bend, at least one corner or at least one other non-linear form that appears to make sense to a person skilled in the art. In particular, the at least one antenna 28a has, as seen in the at least one plane 74a, a U-shaped profile, in particular two sections 158a, 160a which are arranged parallel to one another and are connected to one another by means of a third section 162a arranged transversely, in particular perpendicularly, to the two sections 158a, 160a. In particular, a first section 158a of the antenna 28a covers the machining tool 12a, as seen in the plane 74a, along the first side 76a. In particular, a second section 160a of the antenna 28a covers the machining tool 12a, as seen in the plane 74a, along the third side 80a. In particular, a third section 162a of the antenna 28a covers the machining tool 12a, as seen in the plane 74a, along the second side 78a.

FIG. 7b shows a schematic illustration of a plan view of the machine tool 90a from FIG. 1, in particular the workpiece support surface 68a, with a first alternative sensor unit 14a′. In particular, the sensor unit 14a′ has an antenna 28a′ and a third antenna 32a′. The antenna 28a′ of the sensor unit 14a′ and the third antenna 32a′ have a non-linear profile and surround the machining tool 12a, as seen in a plane 74a, along two sides 76a, 78a, 80a in each case. In particular, the antenna 28a′ surrounds the machining tool 12a, as seen in the plane 74a, along a first side 76a and along a second side 78a. In particular, the third antenna 32a′ surrounds the machining tool 12a, as seen in the plane 74a, along the second side 78a and along a third side 80a. In particular, the antenna 28a′ has, as seen in the plane 74a, an L-shaped profile, in particular two sections 158a′, 160a′ which are arranged transversely, in particular perpendicularly, to one another. In particular, a first section 158a′ of the antenna 28a′ covers the machining tool 12a, as seen in the plane 74a, along the first side 76a. In particular, a second section 160a′ of the antenna 28a′ covers the machining tool 12a, as seen in the plane 74a, along the second side 78a, at least in sections. In particular, the third antenna 32a′, as seen in the plane 74a, has an L-shaped profile, in particular two sections 164a′, 166a′ which are arranged transversely, in particular perpendicularly, to one another. In particular a first section 164a′ of the third antenna 32a′, as seen in the plane 74a, covers the machining tool 12a along the third side 80a. In particular, a second section 166a′ of the third antenna 32a′, as seen in the plane 74a, covers the machining tool 12a along the second side 78a, at least in sections. The antenna 28a′ and the third antenna 32a′ are preferably arranged in an axially symmetrical manner with respect to one another around an imaginary plane running through the output shaft 120a and perpendicularly to the plane 74a. In particular, the sensor unit 14a′ may have an additional antenna which is arranged parallel to the third antenna 32a′ in a plane extending parallel to the plane 74a.

FIG. 7c shows a schematic illustration of a plan view of the machine tool 90a from FIG. 1, in particular the workpiece support surface 68a, with a second alternative sensor unit 14a″. In particular, the sensor unit 14a″ has an antenna 28a″, a third antenna 32a″ and a fourth antenna 34a″. The antenna 28a″, the third antenna 32a″ and the fourth antenna 34a″ have a linear profile and surround a machining tool 12a, as seen in a plane 74a, along one side 76a, 78a, 80a in each case. In particular, the antenna 28a″ covers the machining tool 12a, as seen in the plane 74a, along a first side 76a. In particular, the third antenna 32a″ covers the machining tool 12a, as seen in the plane 74a, along a third side 80a. In particular, the fourth antenna 34a″ covers the machining tool 12a, as seen in the plane 74a, along a second side 78a. The antenna 28a″ and the third antenna 32a″ are preferably arranged parallel to one another in the plane 74a. The fourth antenna 34a″ is preferably arranged perpendicular to, in particular between, the antenna 28a″ and the third antenna 32a″ in the plane 74a. In particular, the sensor unit 14a″ may have additional antennas which are arranged parallel to the third antenna 32a″ and to the fourth antenna 34a″ in a plane extending parallel to the plane 74a.

FIG. 7d shows a schematic illustration of a plan view of the machine tool 90a from FIG. 1, in particular the workpiece support surface 68a, with a third alternative sensor unit 14a′″. In particular, the sensor unit 14a′″ has an antenna 28a′″, a third antenna 32a′″, a fourth antenna 34a′″ and a fifth antenna 36a′″. The antenna 28a′″, the third antenna 32a′″, the fourth antenna 34a′″ and the fifth antenna 36a′″ have a linear profile and surround the machining tool 12a, as seen in a plane 74a, along one side 76a, 78a, 80a, 82a in each case. In particular, the antenna 28a′″ covers the machining tool 12a, as seen in the plane 74a, along a first side 76a. In particular, the third antenna 32a′″ covers the machining tool 12a, as seen in the plane 74a, along a third side 80a. In particular, the fourth antenna 34a′″ covers the machining tool 12a, as seen in the plane 74a, along a second side 78a. In particular, the fifth antenna 36a′″ covers the machining tool 12a, as seen in the plane 74a, along a fourth side 82a. The antenna 28a′″ and the third antenna 32a′″ are preferably arranged parallel to one another in the plane 74a. The fourth antenna 34a′″ and the fifth antenna 36a′″ are preferably arranged parallel to one another in the plane 74a. The fourth antenna 34a′″ and the fifth antenna 36a′″ are preferably arranged perpendicular to, in particular between, the antenna 28a′″ and the third antenna 32a′″ in the plane 74a. In particular, the sensor unit 14a′″ may have additional antennas which are arranged parallel to the third antenna 32a′″, the fourth antenna 34a′″ and the fifth antenna 36a′″ in a plane extending parallel to the plane 74a.

A method for operating a machine tool device, in particular the above-mentioned machine tool device 10a, is described below, in particular with reference to FIGS. 1 to 3. In at least one method step, at least one, in particular the at least one above-mentioned, antenna 28a, 30a is preferably used to emit at least one electric and/or magnetic field, which defines at least one detection area 20a, 22a, 24a around at least one, in particular around the above-mentioned, machining tool 12a of the machine tool device 10a, and/or the at least one antenna 28a, 30a is used to detect at least one foreign body 16a, 18a on the basis of at least one change in at least one electric and/or magnetic field.

In at least one further method step, at least one parameter is preferably at least partially independently adapted on the basis of at least one operating parameter, in particular by the open-loop and/or closed-loop control unit 26a. With respect to further method steps of the method for operating the machine tool device 10a, it is possible to refer to the preceding description of the machine tool device 10a, since this description can also be similarly read on the method and all features with respect to the machine tool device 10a are therefore also considered to be disclosed with respect to the method for operating the machine tool device 10a.

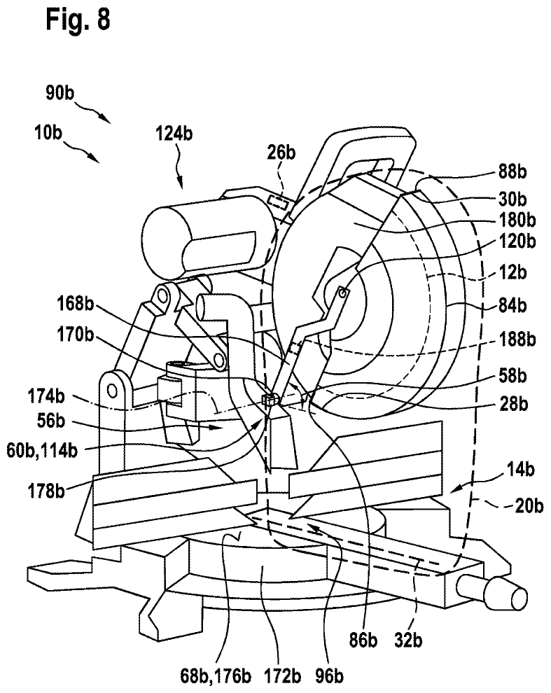

FIGS. 8 to 11 show four further exemplary embodiments of the invention. The following descriptions and the drawings are restricted substantially to the differences between the exemplary embodiments, wherein reference can fundamentally also be made to the drawings and/or the description of the other exemplary embodiments, in particular FIGS. 1 to 7d, with respect to identically designated components, in particular with respect to components having identical reference signs. In order to distinguish the exemplary embodiments, the letter a is appended to the reference signs of the exemplary embodiment in FIGS. 1 to 7d. The letter a is replaced with the letters b to e in the exemplary embodiments in FIGS. 8 to 11.

FIG. 8 shows a schematic perspective illustration of a first alternative machine tool 90b. The machine tool 90b is in the form of a chop and/or miter saw, in particular. The machine tool 90b preferably comprises a machine tool device 10b. The machine tool device 10b is preferably provided for the purpose of cutting and/or sawing a workpiece. The machine tool device 10b comprises, in particular, at least one machining tool 12b, in particular a circular saw blade, which can be driven by motor, at least one, in particular capacitive, sensor unit 14b, and at least one open-loop and/or closed-loop control unit 26b. The sensor unit 14b preferably comprises at least one antenna 28b, 30b, 32b, for example three antennas 28b, 30b, 32b in the present exemplary embodiment, in particular an antenna 28b, a further antenna 30b and a third antenna 32b.

The machine tool device 10b preferably comprises at least one pivoting unit 56b for pivotably mounting the machining tool 12b, wherein the open-loop and/or closed-loop control unit 26b is configured to at least partially independently adapt at least one parameter, in particular at least one detection area 20b, on the basis of at least one pivot angle 58b of the machining tool 12b. The machine tool device 10b preferably comprises the pivoting unit 56b as an alternative or in addition to a mechanical braking unit. The pivoting unit 56b preferably comprises at least one pivot arm 168b, on which the machining tool 12b is mounted, and at least one pivot bearing 170b, in particular a swivel joint, which is provided for the purpose of mounting the pivot arm 168b relative to a base unit 172b of the machine tool device 10b in a pivotable manner, in particular about a pivot axis 174b. In particular, the pivoting unit 56b may comprise at least one further pivot bearing, in particular a tilt joint, which is provided for the purpose of mounting the pivot arm 168b relative to the base unit 172b in a pivotable manner about a further pivot axis, in particular running perpendicularly to the pivot axis 174b (not illustrated any further here). The machine tool device 10b preferably comprises at least one pivot sensor unit 188b which is configured to detect the at least one pivot angle 58b of the machining tool 12b, in particular of the pivot arm 168b, relative to the base unit 172b, in particular relative to a base area 176b of the base unit 172b, and to make it available to the open-loop and/or closed-loop control unit 26b.

The sensor unit 14b, in particular the third antenna 32b, is preferably arranged on, in particular inside, the base unit 172b. In particular, a distance between the third antenna 32b and the machining tool 12b is dependent on the at least one pivot angle 58b of the machining tool 12b. The open-loop and/or closed-loop control unit 26b is preferably configured to actuate the sensor unit 14b such that a minimum extent of the detection area 20b around the machining tool 12b is kept constant independently of the at least one pivot angle 58b of the machining tool 12b. In particular, the open-loop and/or closed-loop control unit 26b is configured to adapt the detection area 20b on the basis of the at least one pivot angle 58b of the machining tool 12b. In particular, the open-loop and/or closed-loop control unit 26b is configured to enlarge the detection area 20b on the basis of the machining tool 12b moving away, in particular pivoting away, from the third antenna 32b. In particular, the open-loop and/or closed-loop control unit 26b is configured to reduce the detection area 20b on the basis of the machining tool 12b approaching, in particular pivoting toward, the third antenna 32b.

The machine tool device 10b preferably comprises at least one blocking unit 60b for blocking the pivoting unit 56b, wherein the open-loop and/or closed-loop control unit 26b is configured to actuate the blocking unit 60b to block the pivoting unit 56b on the basis of at least one signal from the sensor unit 14b. The blocking unit 60b is preferably provided for the purpose of preventing pivoting of the machining tool 12b, in particular the pivot arm 168b. In particular, the blocking unit 60b is provided for the purpose of blocking the at least one pivot bearing 170b. In particular, the blocking unit 60b comprises at least one blocking element 178b, for example a setscrew, a blocking pin, a drag shoe or the like, which is provided for the purpose of blocking the at least one pivot bearing 170b. In particular, blocking of the pivoting unit 56b, in particular the at least one pivot bearing 170b, is in the form of an action to be triggered by the open-loop and/or closed-loop control unit 26b on the basis of the at least one signal from the sensor unit 14b, in particular on the basis of detection of a foreign body. In particular, the open-loop and/or closed-loop control unit 26b is configured to trigger the blocking of the pivoting unit 56b by actuating the blocking unit 60b. In particular, the open-loop and/or closed-loop control unit 26b is configured to actuate the blocking unit 60b as an alternative or in addition to a motor 124b, an output unit, an emergency call unit of the machine tool device 10b and/or a mechanical braking unit, on the basis of the at least one signal from the sensor unit 14b. As an alternative or in addition to the blocking unit 60b, it is conceivable for the machine tool device 10b to have at least one emergency pivoting actuator, wherein the open-loop and/or closed-loop control unit 26b is configured to actuate the emergency pivoting actuator to convey, in particular pivot, the machining tool 12b from a hazardous area 96b on the basis of the at least one signal from the sensor unit 14b.

The machine tool device 10b preferably comprises at least one protective hood 84b for the machining tool 12b, wherein the sensor unit 14b comprises at least one, in particular the above-mentioned, further antenna 30b which is arranged at at least one further end point 88b of the protective hood 84b, which end point faces away from an end point 86b of the protective hood 84b, at which the at least one antenna 28b is arranged. The antenna 28b has, in particular, a non-linear profile which follows a shape of the protective hood 84b at least in sections. The protective hood 84b is preferably provided for the purpose of covering the machining tool 12b, in particular a cutting edge of the machining tool 12b, at least in sections. The protective hood 84b preferably has a partial-disk-shaped, in particular half-disk-shaped, cross section, as seen parallel to an output shaft 120b, on which the machining tool 12b is mounted. In particular, the protective hood 84b is pivotably mounted on and/or about the output shaft 120b. In particular, the machining tool 12b has different hazardous areas, in particular different exposed sections of the cutting edge, on the basis of different pivot angles of the protective hood 84b. In particular, the hazardous area, in particular the exposed cutting edge, of the machining tool 12b may extend from the end point 86b of the protective hood 84b along the cutting edge to the further end point 88b of the protective hood 84b. In the present exemplary embodiment, the machine tool device 10b has, in particular, an additional protective cover 180b for the machining tool 12b. In particular, in the present exemplary embodiment, the hazardous area extends from the end point 86b of the protective hood 84b to the protective cover 180b. In particular, in the illustration in FIG. 8, the protective hood 84b completely covers the machining tool 12b together with the protective cover 180b. In particular, the hazardous area of the machining tool 12b is in the form of an area of the machining tool 12b without a protective hood. The at least two antennas 28b, 30b, in particular the detection area 20b of the at least two antennas 28b, 30b, are preferably shifted, with pivoting of the protective hood 84b, in particular in a manner proportional to a pivot angle of the protective hood 84b.

FIG. 9 shows a circuit diagram of a part of the sensor unit 14b. The sensor unit 14b preferably comprises at least one electrical or electronic shielding circuit 192b which is configured to shield an electric and/or magnetic field, which is emitted by at least one of the antennas 28b, 30b, 32b, along at least one emission direction. An emission direction of at least one of the antennas 28b, 30b, 32b can be set, in particular, by means of the shielding circuit 192b. The shielding circuit 192b is preferably in the form of a high-impedance circuit. The shielding circuit 192b preferably comprises at least one high-impedance electrical component. In particular, at least one of the antennas 28b, 30b, 32b and/or a tuning circuit 196b of the sensor unit 14b is/are connected to an input of the shielding circuit 192b. At least one output of the shielding circuit 192b is preferably connected to a grounding means 194b. The shielding circuit 192b preferably has a higher impedance at the input of the shielding circuit 192b than at the output of the shielding circuit 192b. For example, the impedance at the input of the shielding circuit 192b is of an order of magnitude 100 MΩ and the impedance at the output of the shielding circuit 192b is of an order of magnitude 10 MΩ or less. However, it is also conceivable, in principle, for the orders of magnitude at the input and output of the shielding circuit 192b to differ from the values mentioned above.

FIG. 10 shows a schematic perspective illustration of a second alternative machine tool 90c. The machine tool 90c is, in particular, in the form of a circular table saw. The machine tool 90c preferably comprises a machine tool device 10c. The machine tool device 10c is preferably provided for the purpose of cutting and/or sawing a workpiece. The machine tool device 10c comprises, in particular, at least one machining tool 12c, in particular a circular saw blade, which can be driven by motor, at least one, in particular capacitive, sensor unit 14c, and at least one open-loop and/or closed-loop control unit 26c. The sensor unit 14c preferably comprises at least one antenna 28c, 30c, for example two antennas 28c, 30c in the present exemplary embodiment, in particular an antenna 28c and a further antenna 30c. In particular, the machining tool 12c forms the further antenna 30c. The antenna 28c has, in particular, a non-linear profile and surrounds the machining tool 12c, as seen in at least one plane 74c, along three sides 76c, 78c, 82c. The antenna 28c has, in particular, a U-shaped profile, in particular two sections 158c, 160c which are arranged parallel to one another and are connected to one another by means of a third section 162c which is arranged transversely, in particular perpendicularly, to the two sections 158c, 160c. In particular, the antenna 28c is arranged on, in particular inside, a table 190c of the machine tool device 10c. The open-loop and/or closed-loop control unit 26c is preferably configured to trigger at least braking of the machining tool 12c on the basis of at least one signal from the sensor unit 14c corresponding to detection of a foreign body in a detection area, in particular by actuating a mechanical braking unit 54c of the machine tool device 10c.

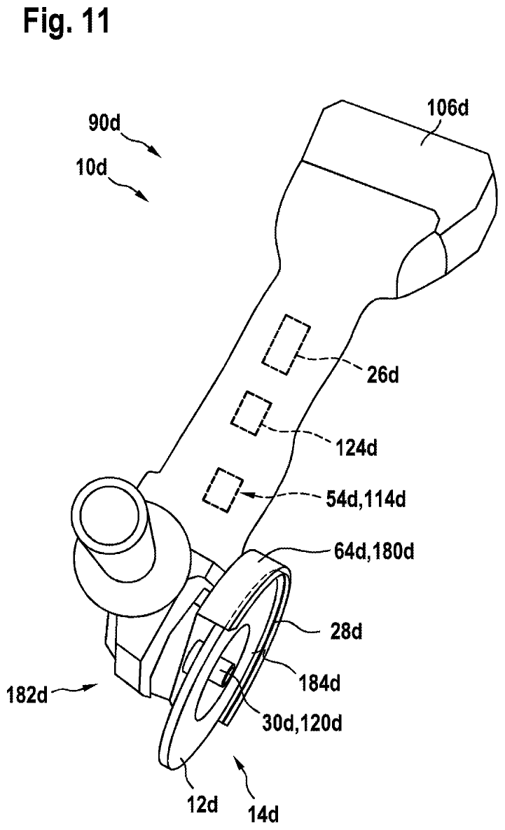

FIG. 11 shows a schematic perspective illustration of a third alternative machine tool 90d. The machine tool 90d is in the form of an angle grinder, in particular. The machine tool 90d preferably comprises a machine tool device 10d. The machine tool device 10d is preferably provided for the purpose of cutting, sawing and/or grinding a workpiece. The machine tool device 10d comprises, in particular, at least one machining tool 12d, in particular an abrasive disk, which can be driven by motor, at least one, in particular capacitive, sensor unit 14d, and at least one open-loop and/or closed-loop control unit 26d. The sensor unit 14d preferably comprises at least one antenna 28d, 30d, for example two antennas 28d, 30d in the present exemplary embodiment, in particular an antenna 28d and a further antenna 30d. In particular, an output shaft 120d of the machine tool device 10d, on which the machining tool 12d is mounted, forms the further antenna 30d. Alternatively or additionally, it is conceivable for the further antenna 30d to be arranged in a flange area 182d of the machine tool device 10d and/or to be formed by the flange area 182d. The antenna 28d has, in particular, a non-linear, in particular semicircular, profile. In particular, the antenna 28d is arranged on an inner side 184d of a protective cover 180d for the machining tool 12d. In particular, the protective cover 180d serves as a shielding unit 64d of the machine tool device 10d. Alternatively or additionally, it is conceivable for the protective cover 180d to form the antenna 28d. The open-loop and/or closed-loop control unit 26d is preferably configured to trigger at least braking of the machining tool 12d on the basis of at least one signal from the sensor unit 14d corresponding to detection of a foreign body in a detection area, in particular by actuating a mechanical braking unit 54d of the machine tool device 10d.

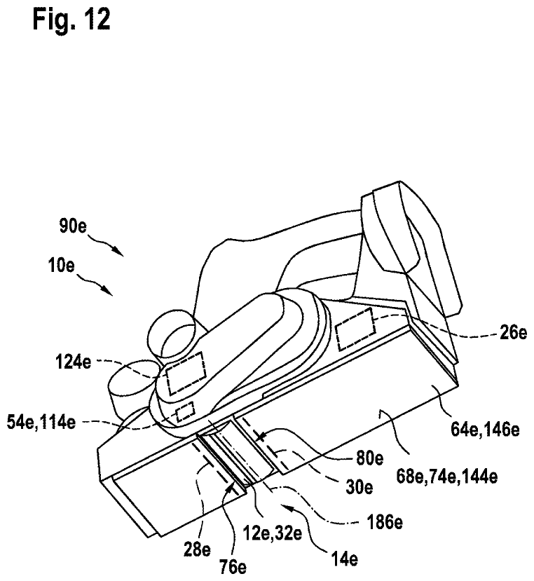

FIG. 12 shows a schematic perspective illustration of a fourth alternative machine tool 90e. The machine tool 90e is, in particular, in the form of a planing machine. The machine tool 90e preferably comprises a machine tool device 10e. The machine tool device 10e is preferably provided for the purpose of planing a workpiece. The machine tool device 10e comprises, in particular, at least one machining tool 12e, in particular a planing roller, which can be driven by motor, at least one, in particular capacitive, sensor unit 14e and at least one open-loop and/or closed-loop control unit 26e. The sensor unit 14e preferably comprises at least one antenna 28e, 30e, 32e, for example three antennas 28e, 30e, 32e in the present exemplary embodiment, in particular an antenna 28e, a further antenna 30e and a third antenna 32e. In particular, the machining tool 12e forms the third antenna 32e. The antenna 28e and the further antenna 30e have, in particular, a linear profile. The antenna 28e and the further antenna 30e cover one side 76e, 80e of the machining tool 12e in each case, as seen in a plane 74e. The antenna 28e and the further antenna 30e preferably extend parallel to one another. In particular, the antenna 28e and the further antenna 30e extend parallel to an axis of rotation 186e of the machining tool 12e. In particular, the antenna 28e and the further antenna 30e are arranged in a sliding plate 146e of the machine tool device 10e. In particular, the sliding plate 146e forms a shielding unit 64e of the machine tool device 10e. The open-loop and/or closed-loop control unit 26e is preferably configured to trigger at least braking of the machining tool 12e on the basis of at least one signal from the sensor unit 14e corresponding to detection of a foreign body in a detection area, in particular by actuating a mechanical braking unit 54e of the machine tool device 10e.

1. A machine tool device comprising:
at least one machining tool operably connected to a motor;
at least one sensor unit configured to detect at least one foreign body in at least one detection area around the at least one machining tool; and
at least one open-loop and/or closed-loop control unit configured to trigger at least one action based on at least one signal from the at least one sensor unit,
wherein the at least one sensor unit comprises at least one antenna configured (i) to emit at least one electric and/or magnetic field, which defines the at least one detection area, and/or (ii) to detect the at least one foreign body based on at least one change in the at least one electric and/or magnetic field.

2. The machine tool device as claimed in claim 1, wherein the at least one open-loop and/or closed-loop control unit is configured to at least partially independently adapt at least one parameter based on at least one operating parameter.

3. The machine tool device as claimed in claim 2, wherein the at least one open-loop and/or closed-loop control unit is configured to at least partially independently calibrate the at least one sensor unit to adapt the at least one detection area based on the at least one operating parameter.

4. The machine tool device as claimed in claim 2, wherein the at least one operating parameter includes (i) a movement parameter, (ii) an orientation parameter, (iii) a machining parameter, and/or (iv) an operator-specific parameter.

5. (canceled)

6. (canceled)

7. (canceled)

8. The machine tool device as claimed in claim 2, further comprising:
at least one further sensor unit configured to record the at least one operating parameter,
wherein the at least one further sensor unit includes at least one sensor element configured to record at least one conductivity characteristic variable of at least one operator.

9. (canceled)

10. The machine tool device as claimed in claim 2, further comprising:
at least one wireless communication unit configured to receive the at least one operating parameter from at least one external unit,
wherein the at least one open-loop and/or closed-loop control unit is configured to trigger the at least one action based on joint evaluation of the at least one signal from the at least one sensor unit and the at least one operating parameter.

11. The machine tool device as claimed in claim 10, wherein the at least one open-loop and/or closed-loop control unit is configured to trigger different actions based on different results of the joint evaluations of the at least one signal from the at least one sensor unit and the at least one operating parameter.

12. (canceled)

13. The machine tool device as claimed in claim 1, wherein:
the at least one sensor unit is configured to provide a plurality of detection areas of different radii around the at least one machining tool, and
the at least one open-loop and/or closed-loop control unit is configured to trigger different actions in a cascaded manner based on different signals from the at least one sensor unit corresponding to detections of the at least one foreign body in different detection areas of the plurality of detection areas.

14. The machine tool device as claimed in claim 1, wherein the at least one open-loop and/or closed-loop control unit is configured to classify different foreign bodies detected by the at least one sensor unit and to trigger different actions based on different classifications.

15. The machine tool device as claimed in claim 1, further comprising:
at least one mechanical braking unit configured to brake the at least one machining tool,
wherein the at least one open-loop and/or closed-loop control unit is configured to use at least one electrical current of a motor braking operation to actuate the at least one mechanical braking unit.

16. The machine tool device as claimed in claim 2, further comprising:
at least one pivoting unit configured to pivotably mount the at least one machining tool,
wherein the at least one open-loop and/or closed-loop control unit is configured to at least partially independently adapt the at least one parameter and/or the at least one detection area based on at least one pivot angle of the at least one machining tool.

17. The machine tool device as claimed in claim 16, further comprising:
at least one blocking unit configured to block the at least one pivoting unit,
wherein the at least one open-loop and/or closed-loop control unit is configured to actuate the at least one blocking unit to block the at least one pivoting unit based on at least the at least one signal from the at least one sensor unit.

18. The machine tool device as claimed in claim 1, further comprising:
at least one protective unit configured to surround the at least one antenna at least in sections, the at least one protective unit configured to protect the at least one antenna from environmental influences.

19. The machine tool device as claimed in claim 1, further comprising:
at least one shielding unit configured to surround the at least one antenna at least in sections, the at least one shielding unit configured to shield the at least one electric and/or magnetic field of the at least one antenna, which defines the at least one detection area, along at least one emission direction.

20. The machine tool device as claimed in claim 1, wherein:
the at least one sensor unit comprises an electrical or electronic shielding circuit configured to shield the at least one electric and/or magnetic field emitted by the at least one antenna along at least one emission direction.

21. The machine tool device as claimed in claim 1, further comprising:
at least one workpiece support surface,
wherein the at least one sensor unit comprises at least one further antenna which has at least one emission direction running antiparallel to at least one emission direction of the at least one antenna and perpendicularly to the at least one workpiece support surface.

22. The machine tool device as claimed in claim 1, wherein the at least one antenna has a non-linear profile and surrounds the at least one machining tool in at least one plane along at least two sides.

23. The machine tool device as claimed in claim 1, further comprising:
at least one protective hood for the at least one machining tool,
wherein the at least one sensor unit comprises at least one further antenna arranged at at least one further end point of the at least one protective hood, the at least one further end point faces away from an end point of the at least one protective hood at which the at least one antenna is arranged.

24. A method for operating the machine tool device as claimed in claim 1, comprising:
Emitting, using the at least one antenna, the at least one electric and/or magnetic field which defines the at least one detection area around the at least one machining tool of the machine tool device; and/or
using the at least one antenna to detect the at least one foreign body based on the at least one change in the at least one electric and/or magnetic field.

25. (canceled)

26. A system having the at least one machine tool as claimed in claim 24, the system further comprising:
at least one display device configured to display at least one hazardous area around the at least one machining tool of the at least one machine tool device,
wherein the display device is configured to adapt the display of the at least one hazardous area based on a change in at least one parameter and/or based on a change in at least one detection area around the at least one machining tool.
